(19) United States
(12) Patent Application Publication
(10) Pub. No.: US 2025/0234206 A1
(43) Pub. Date: Jul. 17, 2025

(54) SHARED BANDS FOR MULTIPLE NETWORKS

(71) Applicant: QUALCOMM Incorporated, San Diego, CA (US)

(72) Inventors: Soo Bum LEE, San Diego, CA (US); George CHERIAN, San Diego, CA (US); Aleksandar DAMNJANOVIC, Del Mar, CA (US)

(21) Appl. No.: 18/410,867

(22) Filed: Jan. 11, 2024

(51) Int. Cl. H04W 16/14; H04W 24/10

(52) U.S. Cl. CPC H04W 16/14; H04W 24/10

(57) ABSTRACT

Some wireless devices communicate with multiple networks. For example, a user equipment (UE) may communicate with a cellular network and a wireless local area network (WLAN). In some cases, licensed use and unlicensed use may occur in the same portion of radio frequency (RF) spectrum or in overlapping portions of RF spectrum. In some examples of the techniques described herein, a UE may relay information between networks to coordinate spectrum usage in the same band. For instance, a cellular network may provide channel sharing information to a UE. The channel sharing information may include a request targeted to another network (e.g., a WLAN) to vacate one or more channels in the band, to reduce transmit signal power for one or more channels, or other channel sharing information. The UE may serve to relay the channel sharing information with the other network.

### FIELD OF TECHNOLOGY

The following relates to wireless communications, including shared bands for multiple networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless devices communicate with multiple networks. For example, a user equipment (UE) may communicate with a cellular network and a wireless local area network (WLAN). Portions of radio frequency (RF) spectrum may be designated for use by one or more wireless networks (e.g., a combination of networks of different types such as a combination of one or more cellular networks and one or more WLAN networks). A portion of RF spectrum may be licensed for use by cellular networks, and another portion of RF spectrum may be designated for unlicensed use. For example, the upper 6 gigahertz (GHz) band (e.g., the 6 GHz band in accordance with International Mobile Telecommunications (IMT) standards) may be allocated to unlicensed users in some parts of the world. In some cases, licensed use and unlicensed use may occur in the same portion of RF spectrum or in overlapping portions of RF spectrum. Some regions (e.g., countries, areas controlled by regulatory bodies, nations, states, or unions, among other examples) may allocate the upper part of the 6 GHz band as unlicensed spectrum for indoor use while licensing the same spectrum for outdoor deployments for coverage.

Rules, procedures, or techniques for accessing networks occupying the same band may improve access and RF spectrum usage. In some examples of the techniques described herein, a UE may relay information between networks to coordinate spectrum usage in the same band. For instance, a cellular network (e.g., Third Generation Partnership Project (3GPP) network) may provide channel sharing information to a UE. The channel sharing information may include a request (from a mobile network operator (MNO), for instance) targeted to another network (e.g., a WLAN) to vacate one or more channels in the band with an indication of a time period for vacating the one or more channels, a request to reduce transmit signal power for one or more channels with an indication of a time period for reducing transmit signal power for the one or more channels, or other channel sharing information. The UE may serve to relay the channel sharing information with the other network.

In some aspects, the channel sharing information may be encoded as an 802.11 enhanced broadcast service (EBCS) uplink frame. For example, the EBCS uplink frame may include a higher layer protocol (HLP) payload. The EBCS uplink frame may include a certificate (e.g., verification certificate) associated with the MNO or network. For example, the EBCS uplink frame may be signed by a private key associated with the certificate. The UE (e.g., non-access point (AP) station (STA)) may include the certificate in the uplink EBCS frame transmitted to an AP. The EBCS uplink frame may indicate a destination (to an authorization server, for instance). The AP (which may generally relay information from the STA or UE, for instance) may relay the HLP to the destination (e.g., server) indicated in the frame via an associated EBCS proxy. The EBCS proxy may verify the signature using the certificate in the uplink frame. For example, the EBCS proxy may verify the EBCS uplink frame and may forward the HLP payload to the destination (e.g., authorization server).

In some aspects, an authorization server may verify the channel sharing request from the MNO. In some examples, the authorization server may be provided by a broadband service provider, the MNO, or an enterprise. The authorization server may evaluate the channel sharing request from the MNO based on a policy(ies) or regulation(s). In some cases, the authorization server may authorize a part of the request or the entire request (e.g., may authorize vacating one or more channels). The authorization server may send a request to the AP to perform an action (e.g., an authorized action) corresponding to the evaluation result. In some examples, the request may be protected based on transport layer security (TLS). The request may be processed (e.g., processed by a broadband operator or WLAN operator) and configured at the AP. In some examples, a broadband service provider associated with a network (e.g., WLAN) may have a service level agreement (SLA) with the MNO for channel sharing operations. Some examples of the techniques described herein may be carried out in IMT-related procedures.

A method by a UE is described. The method may include transmitting, to a first network, a measurement of a signal received from a second network, receiving, from the first network, information for sharing a frequency band between the first network and the second network, where the information for sharing the frequency band is based on the measurement of the signal received from the second network, and transmitting, to the second network, the information for sharing the frequency band between the first network and the second network.

A UE is described. The UE may include one or more memories storing processor executable code, and one or more processors coupled with the one or more memories. The one or more processors may individually or collectively be operable to execute the code to cause the UE to transmit, to a first network, a measurement of a signal received from a second network, receive, from the first network, information for sharing a frequency band between the first network and the second network, where the information for sharing the frequency band is based on the measurement of the signal received from the second network, and transmit, to the second network, the information for sharing the frequency band between the first network and the second network.

Another UE is described. The UE may include means for transmitting, to a first network, a measurement of a signal received from a second network, means for receiving, from the first network, information for sharing a frequency band between the first network and the second network, where the information for sharing the frequency band is based on the measurement of the signal received from the second network, and means for transmitting, to the second network, the information for sharing the frequency band between the first network and the second network.

A non-transitory computer-readable medium storing code is described. The code may include instructions executable by one or more processors to transmit, to a first network, a measurement of a signal received from a second network, receive, from the first network, information for sharing a frequency band between the first network and the second network, where the information for sharing the frequency band is based on the measurement of the signal received from the second network, and transmit, to the second network, the information for sharing the frequency band between the first network and the second network.

Some examples of the method, UEs, and non-transitory computer-readable medium described herein may further include operations, features, means, or instructions for receiving, from the first network, a configuration for the UE to use to measure the signal from the second network and receiving, from the second network, the signal to generate the measurement of the signal from the second network using the configuration received from the first network.

Some examples of the method, UEs, and non-transitory computer-readable medium described herein may further include operations, features, means, or instructions for transmitting the information for sharing the frequency band includes transmitting the information in an EBCS uplink frame.

Some examples of the method, UEs, and non-transitory computer-readable medium described herein may further include operations, features, means, or instructions for receiving the information for sharing the frequency band includes receiving the information from a broadcast via a SIB.

In some examples of the method, UEs, and non-transitory computer-readable medium described herein, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

Some examples of the method, UEs, and non-transitory computer-readable medium described herein may further include operations, features, means, or instructions for performing licensed communication with the first network based on the information for sharing the frequency band or unlicensed communication with the second network based on the information for sharing the frequency band.

Some examples of the method, UEs, and non-transitory computer-readable medium described herein may further include operations, features, means, or instructions for receiving one or more parameters from the second network, the one or more parameters associated with one or more signaling criteria for the first network to accommodate the second network in the frequency band and transmitting the one or more parameters to the first network.

A method by a network entity is described. The method may include obtaining, at a first network from a UE, a measurement of a signal received at the UE from a second network and outputting, to the UE from the first network, information for sharing a frequency band between the first network and the second network, where the information for sharing the frequency band is based on the measurement of the signal received from the second network.

A network entity is described. The network entity may include one or more memories storing processor executable code, and one or more processors coupled with the one or more memories. The one or more processors may individually or collectively be operable to execute the code to cause the network entity to obtain, at a first network from a UE, a measurement of a signal received at the UE from a second network and output, to the UE from the first network, information for sharing a frequency band between the first network and the second network, where the information for sharing the frequency band is based on the measurement of the signal received from the second network.

Another network entity is described. The network entity may include means for obtaining, at a first network from a UE, a measurement of a signal received at the UE from a second network and means for outputting, to the UE from the first network, information for sharing a frequency band between the first network and the second network, where the information for sharing the frequency band is based on the measurement of the signal received from the second network.

A non-transitory computer-readable medium storing code is described. The code may include instructions executable by one or more processors to obtain, at a first network from a UE, a measurement of a signal received at the UE from a second network and output, to the UE from the first network, information for sharing a frequency band between the first network and the second network, where the information for sharing the frequency band is based on the measurement of the signal received from the second network.

Some examples of the method, network entities, and non-transitory computer-readable medium described herein may further include operations, features, means, or instructions for outputting, to the UE from the first network, a configuration for the UE to use to measure the signal from the second network, where the measurement of the signal may be based on the configuration of the UE.

Some examples of the method, network entities, and non-transitory computer-readable medium described herein may further include operations, features, means, or instructions for outputting the information for sharing the frequency band includes broadcasting the information via a SIB.

In some examples of the method, network entities, and non-transitory computer-readable medium described herein, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

Some examples of the method, network entities, and non-transitory computer-readable medium described herein may further include operations, features, means, or instructions for obtaining a measurement report from the UE indicating that a channel of the frequency band may be vacated and discontinuing outputting the information for sharing the frequency band based on the measurement report.

Some examples of the method, network entities, and non-transitory computer-readable medium described herein may further include operations, features, means, or instructions for obtaining one or more parameters from the UE, the one or more parameters associated with one or more signaling criteria for the first network to accommodate the second network in the frequency band and communicating via the frequency band based on the one or more parameters.

A method by an AP is described. The method may include receiving, from a UE, information for sharing a frequency band between a first network and a second network that includes the AP, transmitting, via the second network, the information for sharing the frequency band between the first network and the second network, and receiving, via the second network, a configuration of signaling for the frequency band, the configuration of signaling based on the information for sharing the frequency band.

An AP is described. The AP may include one or more memories storing processor executable code, and one or more processors coupled with the one or more memories. The one or more processors may individually or collectively be operable to execute the code to cause the AP to receive, from a UE, information for sharing a frequency band between a first network and a second network that includes the AP, transmit, via the second network, the information for sharing the frequency band between the first network and the second network, and receive, via the second network, a configuration of signaling for the frequency band, the configuration of signaling based on the information for sharing the frequency band.

Another AP is described. The AP may include means for receiving, from a UE, information for sharing a frequency band between a first network and a second network that includes the AP, means for transmitting, via the second network, the information for sharing the frequency band between the first network and the second network, and means for receiving, via the second network, a configuration of signaling for the frequency band, the configuration of signaling based on the information for sharing the frequency band.

A non-transitory computer-readable medium storing code is described. The code may include instructions executable by one or more processors to receive, from a UE, information for sharing a frequency band between a first network and a second network that includes the AP, transmit, via the second network, the information for sharing the frequency band between the first network and the second network, and receive, via the second network, a configuration of signaling for the frequency band, the configuration of signaling based on the information for sharing the frequency band.

Some examples of the method, APs, and non-transitory computer-readable medium described herein may further include operations, features, means, or instructions for refraining from signaling in a channel of the frequency band based on the configuration of signaling for the frequency band.

Some examples of the method, APs, and non-transitory computer-readable medium described herein may further include operations, features, means, or instructions for reducing a transmit power for signaling in a channel of the frequency band based on the configuration of signaling for the frequency band.

Some examples of the method, APs, and non-transitory computer-readable medium described herein may further include operations, features, means, or instructions for receiving the information for sharing the frequency band includes receiving the information in an EBCS uplink frame.

In some examples of the method, APs, and non-transitory computer-readable medium described herein, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

In some examples of the method, APs, and non-transitory computer-readable medium described herein, the configuration of signaling for the frequency band may be formatted in accordance with transport layer security.

Some examples of the method, APs, and non-transitory computer-readable medium described herein may further include operations, features, means, or instructions for receiving one or more parameters via the second network, the one or more parameters associated with one or more signaling criteria for the first network to accommodate the second network in the frequency band and transmitting the one or more parameters to the UE.

### BRIEF DESCRIPTION OF THE DRAWINGS

FIG. 1 shows an example of a wireless communications system that supports shared bands for multiple networks in accordance with one or more aspects of the present disclosure.

FIG. 2 shows an example of a network architecture that supports shared bands for multiple networks in accordance with one or more aspects of the present disclosure.

FIG. 3 shows an example of a wireless communications network that supports shared bands for multiple networks in accordance with one or more aspects of the present disclosure.

FIG. 4 shows an example of wireless communications systems that support shared bands for multiple networks in accordance with one or more aspects of the present disclosure.

FIG. 5 shows an example of a process flow that supports shared bands for multiple networks in accordance with one or more aspects of the present disclosure.

FIGS. 6 and 7 show block diagrams of devices that support shared bands for multiple networks in accordance with one or more aspects of the present disclosure.

FIG. 8 shows a block diagram of a communications manager that supports shared bands for multiple networks in accordance with one or more aspects of the present disclosure.

FIG. 9 shows a diagram of a system including a device that supports shared bands for multiple networks in accordance with one or more aspects of the present disclosure.

FIGS. 10 and 11 show block diagrams of devices that support shared bands for multiple networks in accordance with one or more aspects of the present disclosure.

FIG. 12 shows a block diagram of a communications manager that supports shared bands for multiple networks in accordance with one or more aspects of the present disclosure.

FIG. 13 shows a diagram of a system including a device that supports shared bands for multiple networks in accordance with one or more aspects of the present disclosure.

FIGS. 14 and 15 show block diagrams of devices that support shared bands for multiple networks in accordance with one or more aspects of the present disclosure.

FIG. 16 shows a block diagram of a communications manager that supports shared bands for multiple networks in accordance with one or more aspects of the present disclosure.

FIG. 17 shows a diagram of a system including a device that supports shared bands for multiple networks in accordance with one or more aspects of the present disclosure.

FIGS. 18 through 23 show flowcharts illustrating methods that support shared bands for multiple networks in accordance with one or more aspects of the present disclosure.

### DETAILED DESCRIPTION

Some wireless devices communicate with multiple networks. For example, a user equipment (UE) may communicate with a cellular network and a wireless local area network (WLAN). Portions of radio frequency (RF) spectrum may be designated for use by one or more wireless networks (e.g., a combination of networks of different types such as a combination of one or more cellular networks and one or more WLAN networks). A portion of RF spectrum may be licensed for use by cellular networks, and another portion of RF spectrum may be designated for unlicensed use. For example, the upper 6 gigahertz (GHz) band (e.g., the 6 GHz band in accordance with International Mobile Telecommunications (IMT) standards) may be allocated to unlicensed users in some parts of the world. In some cases, licensed use and unlicensed use may occur in the same portion of RF spectrum or in overlapping portions of RF spectrum. Some regions (e.g., countries, areas controlled by regulatory bodies, nations, states, or unions, among other examples) may allocate the upper part of the 6 GHz band as unlicensed spectrum for indoor use while licensing the same spectrum for outdoor deployments for coverage. Accordingly, coexistence may become an issue for licensed and unlicensed use in the same band, as one or more signals in a band may interfere with or degrade one or more other signals in the same band. Some networks may not communicate directly due to different signaling structures.

Rules, procedures, or techniques for accessing networks occupying the same band may improve access and RF spectrum usage. In some examples of the techniques described herein, a UE may relay information between networks to coordinate spectrum usage in the same band. For instance, a cellular network (e.g., Third Generation Partnership Project (3GPP) network) may provide channel sharing information to a UE. The channel sharing information may include a request (from a mobile network operator (MNO), for instance) targeted to another network (e.g., a WLAN) to vacate one or more channels in the band (e.g., switch channels) with an indication of a time period for vacating the one or more channels, a request to reduce transmit signal power for one or more channels with an indication of a time period for reducing transmit signal power for the one or more channels, or other channel sharing information. The UE may serve to relay the channel sharing information with the other network.

In some aspects, the channel sharing information may be encoded as an 802.11 enhanced broadcast service (EBCS) uplink frame. For example, the EBCS uplink frame may include a higher layer protocol (HLP) payload. The EBCS uplink frame may include a certificate (e.g., verification certificate) associated with the MNO or network. For example, the EBCS uplink frame may be signed by a private key associated with the certificate. The UE (e.g., non-access point (AP) station (STA)) may include the certificate in the uplink EBCS frame transmitted to an AP. The EBCS uplink frame may indicate a destination (to a server or other device, for instance). The AP (which may generally relay information from the STA or UE, for instance) may relay the HLP to the destination (e.g., server) indicated in the frame via an associated EBCS proxy. The EBCS proxy may verify the signature using the certificate in the uplink frame. For instance, the EBCS proxy may verify the EBCS uplink frame and may forward the HLP payload to the destination. In some examples, the destination may be an authorization server or another device. An authorization server may be a computing device (including one or more processors or one or more memories with instructions) configured to determine whether one or more requests or actions are authorized. In some approaches, an authorization server may indicate whether an action is authorized or may control a device (e.g., AP) to perform an authorized action.

In some aspects, an authorization server may verify the channel sharing request from the MNO. In some examples, the authorization server may be provided by a broadband service provider or may be provided by the MNO. The authorization server may evaluate the channel sharing request from the MNO based on a policy(ies) or regulation(s). In some cases, the authorization server may authorize a part of the request or the entire request (e.g., may authorize vacating one or more channels). The authorization server may send a request to the AP to perform an action (e.g., an authorized action) corresponding to the evaluation result. In some examples, the request may be protected based on transport layer security (TLS). The request may be processed (e.g., processed by a broadband operator or WLAN operator) and configured at the AP. In some examples, a broadband service provider associated with a network (e.g., WLAN) may have a service level agreement (SLA) with the MNO for channel sharing operations. Some examples of the techniques described herein may be carried out in IMT-related procedures.

Aspects of the disclosure are initially described in the context of wireless communications systems. Aspects of the disclosure are also illustrated by and described with reference to a process flow. Aspects of the disclosure are further illustrated by and described with reference to apparatus diagrams, system diagrams, and flowcharts that relate to shared bands for multiple networks.

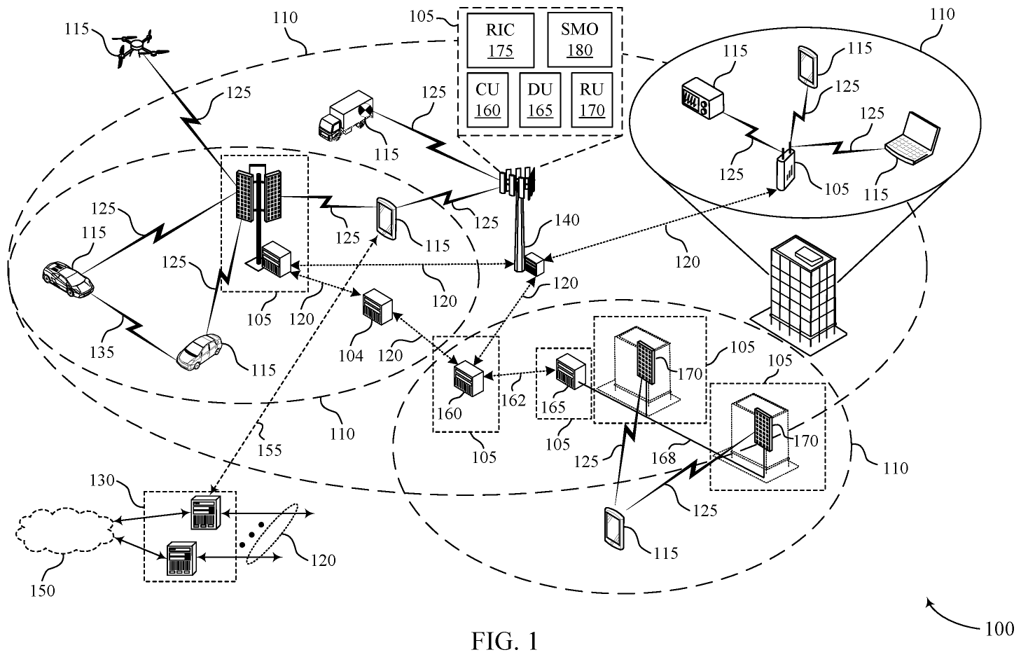

FIG. 1 shows an example of a wireless communications system 100 that supports shared bands for multiple networks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) in which the UEs 115 and the network entity 105 may establish one or more communication links 125. The coverage area 110 may be an example of a geographic area in which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support shared bands for multiple networks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) in which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

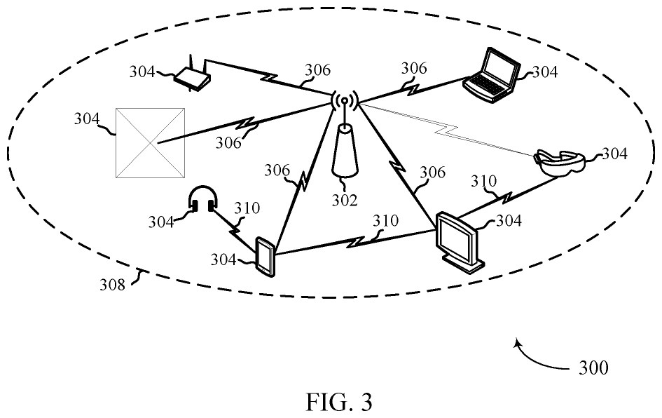

Some wireless devices communicate with multiple networks. For example, a UE 115 may communicate with a first network (e.g., cellular network, network entity 105, donor base station 140, CU 160, DU 165, RU 170, RIC 175, SMO 180, or core network 130, among other examples) and a second network (e.g., a wireless communications network 300 described with reference to FIG. 3, an AP 302 described with reference to FIG. 3, or a WLAN, among other examples). The UE 115 may be referred to as a STA relative to one or more networks (e.g., WLAN). For instance, the UE 115 may be a STA 304 as described with reference to FIG. 3. Portions of RF spectrum may be designated for use by wireless networks. A portion of RF spectrum may be licensed for use by cellular networks, and another portion of RF spectrum may be designated for unlicensed use. For example, the upper 6 GHz band (e.g., the 6 GHz band in accordance with IMT standards) may be allocated to unlicensed users in some parts of the world. In some cases, licensed use and unlicensed use may occur in the same portion of RF spectrum or in overlapping portions of RF spectrum. Some regions (e.g., countries, areas controlled by regulatory bodies, nations, states, or unions, among other examples) may allocate the upper part of the 6 GHz band as unlicensed spectrum for indoor use while licensing the same spectrum for outdoor deployments for coverage. Accordingly, coexistence may become an issue for licensed and unlicensed use in the same band, as one or more signals in a band may interfere with or degrade one or more other signals in the same band. Some networks may not communicate directly due to different signaling structures.

Rules, procedures, or techniques for accessing networks occupying the same band may improve access and RF spectrum usage. In some examples of the techniques described herein, a UE 115 may relay information between networks (e.g., between a cellular network and a WLAN) to coordinate spectrum usage in the same band. For instance, a cellular network (e.g., 3GPP network, network entity 105, donor base station 140, CU 160, DU 165, RU 170, RIC 175, SMO 180, a channel management function (CMF) entity of a cellular network, or core network 130, among other examples) may provide channel sharing information to a UE 115. The channel sharing information may include a request (from a MNO, for instance) targeted to another network (e.g., a wireless communications network 300 or a WLAN, among other examples) to vacate one or more channels in the band, to reduce transmit signal power for one or more channels, an indication of a time period(s) for vacating a channel(s) or reducing transmit signal power for a channel(s), or other channel sharing information. The UE 115 may serve to relay the channel sharing information with the other network.

In some aspects, the channel sharing information may be encoded as an 802.11 EBCS uplink frame. For example, the EBCS uplink frame may include a HLP payload. The EBCS uplink frame may include a certificate (e.g., verification certificate) associated with the MNO or network. For example, the EBCS uplink frame may be signed by a private key associated with the certificate. The UE 115 (e.g., non-AP STA) may include the certificate in the uplink EBCS frame transmitted to an AP (e.g., the AP 302 described with reference to FIG. 3). The EBCS uplink frame may indicate a destination (to an authorization server, for instance). The AP (which may generally relay information from the STA or UE, for instance) may relay the HLP to the destination (e.g., server) indicated in the frame via an associated EBCS proxy. The EBCS proxy may verify the signature using the certificate in the uplink frame. For example, the EBCS proxy may verify the EBCS uplink frame and may forward the HLP payload to the destination (e.g., authorization server).

In some aspects, an authorization server may verify the channel sharing request from the MNO. In some examples, the authorization server may be provided by a broadband service provider or may be provided by the MNO. The authorization server may evaluate the channel sharing request from the MNO based on a policy(ies) or regulation(s). In some cases, the authorization server may authorize a part of the request or the entire request (e.g., may authorize vacating one or more channels). The authorization server may send a request to the AP to perform an action (e.g., an authorized action) corresponding to the evaluation result. In some examples, the request may be protected based on TLS. The request may be processed (e.g., processed by a broadband operator or WLAN operator) and configured at the AP. In some examples, a broadband service provider associated with a network (e.g., WLAN) may have an SLA with the MNO for channel sharing operations. Some examples of the techniques described herein may be carried out in IMT-related procedures.

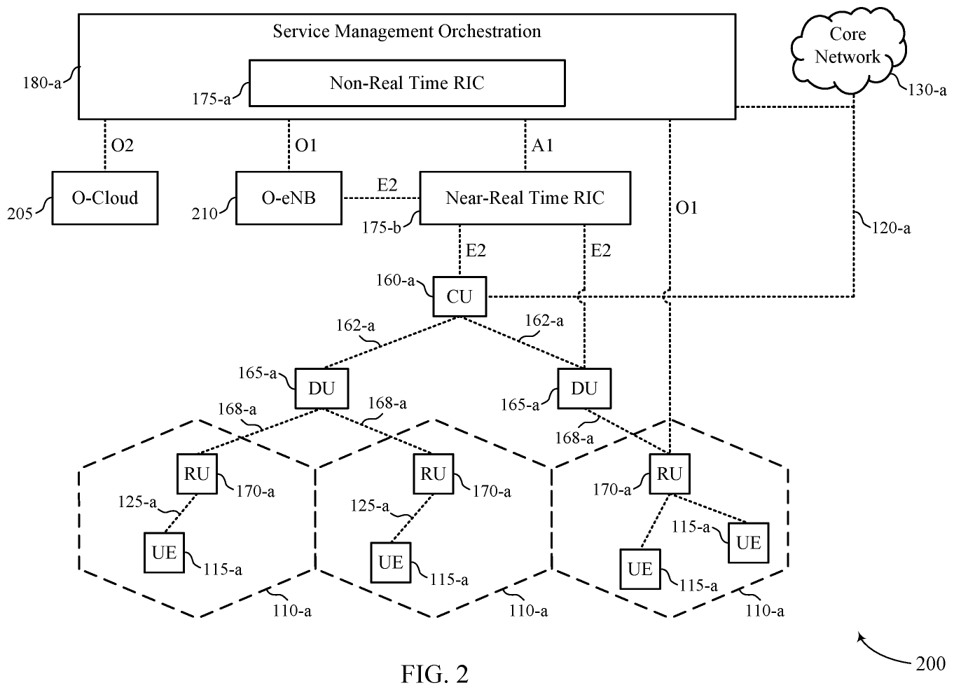

FIG. 2 shows an example of a network architecture 200 (e.g., a disaggregated base station architecture, a disaggregated RAN architecture) that supports shared bands for multiple networks in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals using a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, using a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions using an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

FIG. 3 shows an example of a wireless communications network 300 that supports shared bands for multiple networks in accordance with one or more aspects of the present disclosure. According to some aspects, the wireless communications network 300 can be an example of a WLAN such as a Wi-Fi network. For example, the wireless communications network 300 can be a network implementing at least one of the Institute of Electrical and Electronics Engineers (IEEE) 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communications network 300 can be an example of a cellular radio access network (RAN), such as a 5G or 6G RAN that implements one or more cellular protocols such as those specified in one or more 3GPP standards. In some other examples, the wireless communications network 300 can include a WLAN that functions in an interoperable or converged manner with one or more cellular RANs to provide greater or enhanced network coverage to wireless communication devices within the wireless communications network 300 or to enable such devices to connect to a cellular network's core, such as to access the network management capabilities and functionality offered by the cellular network core.

The wireless communications network 300 may include numerous wireless communication devices including at least one wireless AP 302 and any number of wireless STAs 304. In some implementations, the term “wireless device,” as used herein, may refer to a STA 304 or an AP 302. While only one AP 302 is shown in FIG. 3, the wireless communications network 300 can include multiple APs 302. The AP 302 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 304 also may be referred to as a mobile station (MS), a mobile device, a mobile handset, a wireless handset, an access terminal (AT), a user equipment (UE), a subscriber station (SS), or a subscriber unit, among other examples. The STAs 304 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 302 and an associated set of STAs 304 may be referred to as a basic service set (BSS), which is managed by the respective AP 302. FIG. 3 additionally shows an example coverage area 308 of the AP 302, which may represent a basic service area (BSA) of the wireless communications network 300. The BSS may be identified by STAs 304 and other devices by a service set identifier (SSID), as well as a basic service set identifier (BSSID), which may be a medium access control (MAC) address of the AP 302. The AP 302 may periodically broadcast beacon frames (“beacons”) including the BSSID to enable any STAs 304 within wireless range of the AP 302 to “associate” or re-associate with the AP 302 to establish a respective communication link 306 (hereinafter also referred to as a “Wi-Fi link”), or to maintain a communication link 306, with the AP 302. For example, the beacons can include an identification or indication of a primary channel used by the respective AP 302 as well as a timing synchronization function (TSF) for establishing or maintaining timing synchronization with the AP 302. The AP 302 may provide access to external networks to various STAs 304 in the wireless communications network 300 via respective communication links 306.

To establish a communication link 306 with an AP 302, each of the STAs 304 may be configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 304 listens for beacons, which are transmitted by respective APs 302 at periodic time intervals referred to as target beacon transmission times (TBTTs). To perform active scanning, a STA 304 generates and sequentially transmits probe requests on each channel to be scanned and listens for probe responses from APs 302. Each STA 304 may identify, determine, ascertain, or select an AP 302 with which to associate in accordance with the scanning information obtained through the passive or active scans, and to perform authentication and association operations to establish a communication link 306 with the selected AP 302. The selected AP 302 assigns an association identifier (AID) to the STA 304 at the culmination of the association operations, which the AP 302 uses to track the STA 304.

As a result of the increasing ubiquity of wireless networks, a STA 304 may have the opportunity to select one of many BSSs within range of the STA 304 or to select among multiple APs 302 that together form an extended service set (ESS) including multiple connected BSSs. For example, the wireless communications network 300 may be connected to a wired or wireless distribution system that may enable multiple APs 302 to be connected in such an ESS. As such, a STA 304 can be covered by more than one AP 302 and can associate with different APs 302 at different times for different transmissions. Additionally, after association with an AP 302, a STA 304 also may periodically scan its surroundings to find a more suitable AP 302 with which to associate. For example, a STA 304 that is moving relative to its associated AP 302 may perform a “roaming” scan to find another AP 302 having more desirable network characteristics such as a greater received signal strength indicator (RSSI) or a reduced traffic load.

In some implementations, STAs 304 may form networks without APs 302 or other equipment other than the STAs 304 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communications network 300. In such examples, while the STAs 304 may be capable of communicating with each other through the AP 302 using communication links 306, STAs 304 also can communicate directly with each other via direct wireless communication links 310. Additionally, two STAs 304 may communicate via a direct communication link 310 regardless of whether both STAs 304 are associated with and served by the same AP 302. In such an ad hoc system, one or more of the STAs 304 may assume the role filled by the AP 302 in a BSS. Such a STA 304 may be referred to as a group owner (GO) and may coordinate transmissions within the ad hoc network. Examples of direct wireless communication links 310 include Wi-Fi Direct connections, connections established by using a Wi-Fi Tunneled Direct Link Setup (TDLS) link, and other P2P group connections.

In some networks, the AP 302 or the STAs 304, or both, may support applications associated with high throughput or low-latency requirements, or may provide lossless audio to one or more other devices. For example, the AP 302 or the STAs 304 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 302 or the STAs 304 may support an extended personal audio network enabling communication with the two or more peripheral devices. Additionally, the AP 302 and STAs 304 may support additional ULL applications such as cloud-based applications (such as VR cloud gaming) that have ULL and high throughput requirements.

As indicated above, in some implementations, the AP 302 and the STAs 304 may function and communicate (via the respective communication links 306) according to one or more of the IEEE 802.11 family of wireless communication protocol standards. These standards define the WLAN radio and baseband protocols for the physical (PHY) and MAC layers. The AP 302 and STAs 304 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted using a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 302 and STAs 304 in the WLAN wireless communications network 300 may transmit PPDUs using an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some implementations of the APs 302 and STAs 304 described herein also may communicate in other frequency bands that may support licensed or unlicensed communications. For example, the APs 302 or STAs 304, or both, also may be capable of communicating using licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11bc, 802.11be, and 802.11bn standard amendments may be transmitted using one or more of the 2.4 GHz, 5 GHz, or 6 GHz bands, each of which is divided into multiple 20 MHz channels. As such, these PPDUs are transmitted using a physical channel having a minimum bandwidth of 20 MHz, but larger channels can be formed through channel bonding. For example, PPDUs may be transmitted using physical channels having bandwidths of 40 MHz, 80 MHz, 160 MHz, 240 MHz, 320 MHz, 480 MHz, or 640 MHz by bonding together multiple 20 MHz channels.

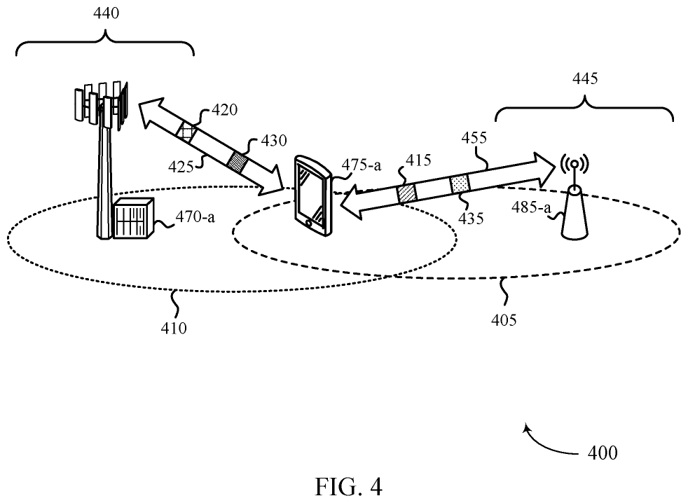

FIG. 4 shows an example of wireless communications systems 400 that support shared bands for multiple networks in accordance with one or more aspects of the present disclosure. The wireless communication systems 400 may include a first network 440 and a second network 445. In some examples, one or more of the wireless communication systems 400 may implement aspects of the wireless communications system 100, the network architecture 200, or the wireless communications network 300. In some aspects, the first network 440 may be an example of the wireless communications system 100 or the second network 445 may be an example of the wireless communications network 300.

The first network 440 may include a network entity 470-a. The network entity 470-a may provide communication service within a cell area 410. In some examples, the first network 440 may be a cellular network (e.g., a 3GPP network). The first network 440 may include a UE 475-a or may provide communication service to the UE 475-a. For example, the network entity 470-a may communicate with (e.g., transmit a signal to or receive a signal from) the UE 475-a via a first communication resource 425. The first communication resource 425 may include one or more resources (e.g., time, frequency, or spatial resources) for signaling. Examples of the first communication resource 425 may include a broadcast channel, a control channel, a shared channel, a data channel, an uplink channel, a downlink channel, a random access channel, another channel, or any combination thereof. The first communication resource 425 between the UE 475-a and the network entity 470-a may be an example of the communication links 125 described with respect to FIG. 1. In some examples, the network entity 470-a may output (e.g., transmit) one or more signals or information described herein via physical layer signaling or higher layer signaling (e.g., RRC signaling or system information signaling, among other examples). With reference to FIG. 1 or FIG. 2, the network entity 470-a may be an example of a network entity 105, a RU 170-a, a DU 165-a, a CU 160-a, a CMF entity, or a combination thereof. In some examples, network entity 470-a functionality may be split or combined between entities (e.g., a RU, a DU, a CU, or a CMF entity).

The second network 445 may include an AP 485-a. The AP 485-a may provide communication service within a coverage area 405. In some examples, the second network 445 may include the UE 475-a or may provide communication service to the UE 475-a. For example, the AP 485-a may communicate with (e.g., transmit a signal to or receive a signal from) the UE 475-a via a second communication resource 455. The second communication resource 455 may include one or more resources (e.g., time, frequency, or spatial resources) for signaling. Examples of the second communication resource 425 may include a broadcast channel, a control channel, a shared channel, a data channel, an uplink channel, a downlink channel, a random access channel, another channel, or any combination thereof. The second communication resource 455 between the UE 475-a and the AP 485-a may be an example of the communication links 306 described with respect to FIG. 3. The AP 485-a may be an example of the AP 302 described with reference to FIG. 3. For instance, the second network 445 may be a WLAN (e.g., a Wi-Fi network).

The UE 475-a may be an example of the UE 115 described with reference to FIG. 1, the UE 115-a described with reference to FIG. 2, the STA 304 described with reference to FIG. 3, or a combination thereof. In some cases, the UE 475-a may be located in the cell area 410 and in the coverage area 405. In some examples, the cell area 410 may be located in the coverage area 405, the cell area 410 may partially overlap with the coverage area 405, or the cell area 410 may be located in the coverage area 405.

The second network 445 (e.g., the AP 485-a) may transmit a signal 415 to the UE 475-a. In some aspects, the signal 415 may be a beacon (e.g., a Wi-Fi beacon sent from the AP 485-a), broadcast signal, synchronization signal, other signal, or any combination thereof.

The UE 475-a may receive the signal 415. In some examples, the UE 475-a may ascertain one or more measurements based on the signal 415. For instance, the UE 475-a may perform one or more measurements (e.g., signal strength measurement(s), received signal strength indicator (RSSI), signal-to-noise ratio (SNR), among other examples) based on the signal 415.

The UE 475-a may transmit, to the first network 440 (e.g., the network entity 470-a), a measurement 420 of the signal 415 received from the second network 445. For example, the UE 475-a may report the measurement 420 (e.g., measurement of the Wi-Fi beacon from the AP 485-a) to the first network 440. The measurement 420 may be included in a measurement report or may be a measurement report.

In some approaches, the first network 440 (e.g., the network entity 470-a) may output, to the UE 475-a, a configuration for the UE 475-a to use to measure the signal 415 from the second network 445 (previous to the reception or measurement of the signal 415, for instance). For example, the UE 475-a may receive, from the first network 440, a configuration (via RRC signaling, for instance) for the UE 475-a to use to measure the signal 415 received from the second network 445. The measurement of the signal 415 may be based on the configuration of the UE 475-a. For instance, the UE 475-a may receive, from the second network 445, the signal 415 to generate the measurement of the signal 415 from the second network 445 using the configuration received from the first network 440. In some examples, the configuration may indicate an instruction for the UE 475-a to measure the signal 415, a frequency range in which to perform the measurement, or other information to configure the UE 475-a to measure the signal 415. For instance, the configuration may be a Wi-Fi measurement configuration.

In some examples, the network 440 may include one or more nodes or entities to configure the UE 475-a to measure the signal 415. For instance, a CMF entity may configure the UE 475-a to measure Wi-Fi signals, where the CMF is a 3GPP system network function. In some examples, an operations, administration, and maintenance (OAM) node may perform the role of the CMF. The OAM may configure a radio access network (RAN) node. The RAN node may configure the UE 475-a for measurement via RRC signaling. The UE 475-a may measure the signal 415 (e.g., one or more Wi-Fi signals) and report the measurement 420 to the CMF entity or RAN node.

The network entity 470-a may obtain, at the first network 440 from the UE 475-a, the measurement 420 of the signal 415 received at the UE 475-a from the second network 445. The network entity 470-a (e.g., RAN node or CMF entity, among other examples) may determine information 430 for sharing a frequency band based on the measurement 420 of the signal 415 received from the second network 445. The frequency band may be a band (e.g., a partially or fully overlapping band) in which the first network 440 and the second network 445 may signal. For instance, the frequency band may include a 6 GHz band or another band. While some examples of the techniques are described herein with reference to a 6 GHz band, some examples of the techniques may be applied to other frequency bands where multiple networks may signal.

In some approaches, determining the information 430 may include determining whether the measurement 420 indicates that the second network 445 is communicating (e.g., transmitting or receiving) in one or more channels of the frequency band (e.g., in one or more channels of the frequency band being utilized by the first network 440). The first network 440 (e.g., network entity 470-a) may determine one or more channels to request that the second network 445 vacate or reduce transmit power. For instance, if the network entity 470-a determines that the second network 445 is signaling in one or more channels currently being utilized (or anticipated for utilization by the network entity 470-a), the network entity 470-a may generate information 430 corresponding to the one or more channels. In some examples, the information 430 may indicate a Wi-Fi channel configuration.

In some approaches, determining the information 430 may include determining a time period to vacate one or more channels or to reduce transmit power in one or more channels. For instance, the network entity 470-a may have scheduled communications in the one or more channels (e.g., conflicting channels), and the time period may indicate a target time period to complete the scheduled communications or a time period before renewing a request to vacate or reduce transmit power.

In some approaches, determining the information 430 may include generating a certificate or signing a certificate. For example, the network entity 470-a may generate a certificate associated with the first network 440 or may sign a certificate associated with the first network 440.

In some examples, the information 430 for sharing the frequency band may include a certificate associated with the first network 440, a control indication to vacate a channel of the frequency band (e.g., switch channels), a control indication to reduce transmit power in a channel of the frequency band, an indication of a time period for one or more control indications, an indication of time, an identifier of the first network 440, a destination address (e.g., a destination address, such as an Internet protocol (IP) address, of an authorization server), or any combination thereof. The identifier of the first network 440 may indicate an identification of the network entity 470-a (e.g., a requesting MNO associated with the first network 440). For instance, the identifier of the first network 440 may be a RAN node identifier (e.g., a new radio cell global identity (NCGI)). The identifier of the first network 440 may be utilized to counter relay attacks in some approaches.

In some aspects, the certificate may be a verification certificate in accordance with public key cryptography. For instance, the first network 440 (e.g., an entity of the first network) may provide a certificate that indicates the identity of the first network 440 or that is associated with the first network 440 (e.g., an MNO). In some examples, the first network 440 (e.g., a RAN node) may generate the channel sharing information 430 and may sign the channel sharing information 430. For instance, the first network 440 (e.g., the network entity 470-a of the first network 440) may sign the certificate using a private key associated with the first network 440.

In some aspects, the information 430 may include a control indication to vacate a channel of the frequency band. For instance, the control indication to vacate a channel may request or instruct the second network 445 to refrain from utilizing (e.g., transmitting in a frequency range of) one or more channels of the frequency band. The indication may identify the channel(s) or may indicate the request or instruction to vacate a channel(s). A channel may be a channel corresponding to the second network 445, a channel corresponding to the first network 440, one or more channels of the second network 445 overlapping with a channel of the first network 440, one or more channels of the first network 440 overlapping with a channel of the second network 445, or any combination thereof. The one or more channels may include one or more subbands in the frequency band.

In some aspects, the information 430 may include a control indication to reduce transmit power in a channel of the frequency band. For instance, the control indication to reduce transmit power in a channel may request or instruct the second network 445 to reduce transmit power in one or more channels of the frequency band. The indication may identify the channel or may indicate an amount of transmit power reduction for a channel.

In some examples, the information 430 for sharing the frequency band may include an indication of a time period for one or more control indications. The indication of the time period may be associated with one or more control indications. For instance, the information 430 may include an indication of one or more time periods for vacating one or more channels or an indication of one or more time periods for reducing transmit power in one or more channels, or any combination thereof. The time period may indicate a period in which the one or more control indications are valid.

In some examples, the information 430 for sharing the frequency band may include an indication of time. The indication of time may indicate a coordinated universal time (UTC), a timestamp in a beacon frame, or another time. The indication of time may be utilized to counter replay attacks in some approaches.

The network entity 470-a may output (e.g., transmit), to the UE 475-a from the first network 440, the information 430 for sharing the frequency band between the first network 440 and the second network 445. For instance, a RAN node or CMF entity may send the determined information 430 to the UE 475-a. In some approaches, the network entity 470-a may broadcast the information 430 via one or more system information blocks (SIBs). For instance, the network entity 470-a (e.g., a RAN node) may broadcast the information 430 (e.g., signed information for sharing a frequency band) via a SIB.

The UE 475-a may receive, from the first network 440, the information 430 for sharing the frequency band between the first network 440 and the second network 445. The information 430 for sharing the frequency band may be based on the measurement 420 of the signal 415 received from the second network 445 as described herein. In some examples, the UE 475-a may receive the information 430 for sharing the frequency band from a broadcast via a SIB.

The UE 475-a may transmit, to the second network 445, the information 435 for sharing the frequency band between the first network 440 and the second network 445. For instance, the UE 475-a may forward the information 435 for sharing the frequency band to the AP 485-a (e.g., a Wi-Fi AP).

In some examples, the UE 475-a may transmit the information 435 in an EBCS uplink frame. For instance, the UE 475-a may encode the information 435 for sharing the frequency band as an 802.11 EBCS uplink frame. The UE 475-a (that reads the SIB message, for example) may forward the EBCS uplink frame to the AP 485-a. The EBCS uplink frame may include an HLP payload. In some aspects, the EBCS uplink frame may include a certificate (e.g., MNO certificate). For example, the EBCS uplink frame may be signed by a private key associated with the certificate (e.g., the certificate associated with the first network 440 or MNO). Utilizing the certificate may enable the information 435 to be transmitted to the AP 485-a without setting up a connection with the AP 485-a in some approaches. For instance, the UE 475-a may broadcast the information 435 without associating with the AP 485-a (e.g., without explicitly joining the second network 445 or requesting resources for communication with the AP 485-a). In some examples, the EBCS uplink frame may indicate a destination (e.g., destination address) to an authorization server (not shown in FIG. 4).

The second network 445 (e.g., the AP 485-a) may receive, from the UE 475-a, the information 435 for sharing the frequency band between the first network 440 and the second network 445. In some examples, the AP 485-a may receive the information 435 for sharing the frequency band in an EBCS uplink frame.

The AP 485-a may transmit, via the second network 445, the information 435 for sharing the frequency band between the first network 440 and the second network 445. In some examples, the AP 485-a may transmit the information 435 to a proxy device or destination device (e.g., authorization server). A proxy device may be a computing device (including one or more processors or one or more memories with instructions) configured to verify information or authenticate a sender. For instance, the AP 485-a may relay or forward the HLP payload to a destination device (e.g., server) indicated in the EBCS frame via an associated EBCS proxy (not shown in FIG. 4). In some approaches, the AP 485-a and the destination device may communicate (e.g., transmit or receive information) via a secure link. For example, the information 435 may be communicated via a secure link between the AP 485-a and the destination device. In some examples, an SLA for a band sharing operation may exist between the operator of the AP 485-a and the operator of the destination device (e.g., authorization server).

The proxy device (e.g., EBCS proxy) may verify the information 435, the EBCS uplink frame, or a combination thereof. In some approaches, the certificate verification and the EBCS frame verification may be separate or different. For instance, the proxy device may verify the certificate indicated in the information 435 (e.g., may first verify the certificate that is included in the EBCS frame). In some approaches, the certificate may be verified based on a root certificate authority (CA) certificate or a provisioned (e.g., previously provisioned) MNO certificate. The proxy device (e.g., EBCS proxy) may verify the EBCS frame using the certificate included in the EBCS uplink frame (after verifying the information 435, for instance). In some examples, the proxy device may verify the signed information using the certificate associated with the first network 440 and included in the EBCS frame. Operation may proceed in a case that the signed information is verified successfully using the public key.

The proxy device may send the information 435 to a destination device (e.g., server). For example, the proxy device may forward the HLP payload to an authorization server. The authorization server may evaluate (e.g., verify) the information 435 from the first network 440 (e.g., a channel sharing request from an MNO associated with the first network 440). In some examples, the authorization server may be operated by a broadband service provider, by a MNO, or a combination thereof. A broadband service provider associated with the second network may have an SLA with the MNO associated with the first network 440 for band sharing operations. For example, the SLA may indicate (e.g., govern) whether or how the first network 440 and the second network 445 may share a frequency band (e.g., manage one or more channels of the frequency band).

In some examples, the authorization server may evaluate the information 435. For instance, the authorization server may determine whether the one or more control indications are permitted in accordance with one or more rules (e.g., one or more rules in accordance with the SLA(s), policy(ies), governing law(s), or governing regulation(s), among other examples). For instance, the authorization server may determine whether to grant or deny the one or more control indications based on the one or more rules (e.g., based on whether band sharing is permitted in accordance with one or more policies, one or more laws, one or more regulations, one or more SLAs, or any combination thereof).

In some cases, the authorization server may determine a configuration of signaling for the frequency band. The configuration of signaling may indicate a configuration for the AP 485-a to employ for signaling in the frequency band. The configuration of signaling may be determined based on the information 435 (e.g., the one or more control indications) or the one or more rules. For instance, the configuration of signaling may request or instruct (e.g., command) the AP 485-a to vacate one or more channels of the frequency band for a time period or to reduce transmit power in one or more channels of the frequency band for a time period based on the one or more rules and the one or more control indications. In some examples, the configuration of signaling may be utilized to configure the AP 485-a signaling to an extent permitted by the one or more rules. In some cases, the authorization server may determine the configuration of signaling to authorize one or more of the control indications (e.g., all or part of a request). For instance, the configuration of signaling may indicate one or more authorized control indications for one or more associated time periods (or part of the one or more associated time period(s)) indicated by the information 435. In some cases, the authorization server may reject one or more of the control indications if one or more control indications are prohibited by the one or more rules (e.g., prohibited by a policy, SLA, law, regulation, or any combination thereof).

The authorization server may send the configuration of signaling to one or more APs (e.g., to the AP 485-a, to one or more APs in a downstream). For instance, the configuration of signaling may be utilized to configure the AP 485-a or multiple APs concurrently. The AP 485-a may receive, via the second network 445 (e.g., from the authorization server), the configuration of signaling for the frequency band. The configuration of signaling may be based on the information 435 for sharing the frequency band as described herein. In some aspects, the configuration of signaling for the frequency band may be formatted in accordance with (e.g., protected based on) TLS. In some examples, one or more of the functions or operations described with reference to the proxy device or the destination device may be performed (e.g., may instead be performed) by the AP 485-a.

The AP 485-a may perform one or more actions (e.g., authorized actions) based on the configuration of signaling or may apply the configuration of signaling. For example, the AP 485-a may refrain from signaling in a channel of the frequency band based on the configuration of signaling for the frequency band. For instance, the AP 485-a may vacate one or more channels for a time period in accordance with the configuration of the signaling based on the evaluation performed by the authorization server. In some examples, the AP 485-a may reduce a transmit power for signaling in a channel of the frequency band based on the configuration of signaling for the frequency band. For instance, the AP 485-a may reduce a transmit power for signaling in one or more channels for a time period in accordance with the configuration of the signaling based on the evaluation performed by the authorization server. In some approaches, the configuration of signaling may indicate an amount of transmit power reduction to perform, which the AP 485-a may apply. In some examples, the configuration of signaling may be applied based on a time period (e.g., a time period requested by a MNO or indicated by a policy). For instance, while a MNO may have requested a channel to be vacated for two hours, the authorization server may accept one hour based on a policy.

In some examples, the authorization server or the AP 485-a may determine one or more parameters. The one or more parameters may be generated in addition to, or alternatively from, the configuration of signaling. For instance, one or more rules (e.g., policy(ies), SLA(s), law(s), regulation(s), or any combination thereof) may cause the authorization server of the AP 485-a to reject one or more of the control indications or to generate the one or more parameters. The one or more parameters may be associated with one or more signaling criteria for the first network 440 (e.g., the network entity 470-a) to accommodate the second network 445 in the frequency band. For instance, the one or more signaling criteria may indicate that the first network (e.g., network entity 470-a) may include or may be based on the one or more rules, which may indicate that the first network 440 may accommodate the second network 445. In some cases, the parameters may indicate a request, instruction, or command for the first network (e.g., network entity 470-a) to vacate one or more channels or to reduce transmit power in one or more channels.

In some approaches, the authorization server may utilize the information 435 for sharing the frequency band (e.g., EBCS uplink frame(s)) to generate a jamming graph. The jamming graph may represent one or more channels in which a conflict may occur (e.g., one or more channels of the frequency band that the first network 440 and the second network 445 are targeting for communication). In some examples, jamming graph may have an associated expiration period (e.g., seconds, minutes, hours, days, or months, among other examples). The one or more parameters may be updated based on the one or more rules (e.g., policy(ies), law(s), regulation(s), or SLA(s), among other examples). In some examples, the one or more rules may be applied to generate the configuration of signaling or the parameter(s) based on an estimate of traffic (e.g., traffic estimated based on artificial intelligence, machine learning, or another technique).

In some examples, the AP 485-a may receive the one or more parameters via the second network 445. The one or more parameters may be associated with one or more signaling criteria for the first network 440 to accommodate the second network 445 in the frequency band as described herein. The AP 485-a may transmit the one or more parameters to the UE 475-a. The UE 475-a may receive the one or more parameters from the second network 445. The UE 475-a may transmit the one or more parameters to the first network 440 (e.g., the network entity 470-a).

The first network 440 (e.g., the network entity 470-a) may obtain the one or more parameters from the UE 475-a. In some cases, the first network (e.g., the network entity 470-a) may communicate via the frequency band based on the one or more parameters. For example, the network entity 470-a may vacate one or more channels of the frequency band or may reduce transmit power in one or more channels of the frequency band in accordance with the one or more parameters. In some cases, the first network 440 (e.g., the network entity 470-a) may reject the one or more parameters in accordance with one or more conditions (e.g., policy(ies), SLA(s), law(s), regulation(s), among other examples).

In some examples, the UE 475-a may perform licensed communication with the first network 440 based on the information for sharing the frequency band or may perform unlicensed communication with the second network 445 based on the information for sharing the frequency band. For instance, the UE 475-a may communicate with the network entity 470-a via one or more channels that are vacated by (or signaled with reduced power by) the AP 485-a. Additionally, or alternatively, the UE 475-a may communicate with the network entity 470-a via one or more channels that are vacated by (or signaled with reduced power by) the AP 485-a.

In some aspects, the first network (e.g., network entity 470-a) may obtain a measurement report from the UE 475-a indicating that a channel of the frequency band is vacated. The UE 475-a may occasionally or periodically transmit one or more signal measurements to the first network 440 (e.g., network entity 470-a), where the signal measurement(s) are associated with the second network 445 (e.g., AP 485-a). For instance, after the measurement 420 of the signal 415, the UE 475-a may transmit one or more measurement reports. The measurement report(s) may indicate whether the second network 445 has vacated one or more channels or has reduced a transmit power (relative to an earlier signal measurement, for example) in one or more channels.

The first network 440 (e.g., the network entity 470-a) may discontinue outputting the information 430 for sharing the frequency band based at least in part on the measurement report. For instance, the network entity 470-a may occasionally or periodically transmit (e.g., broadcast) the information 430 for sharing the frequency band. In a case that a measurement report indicates that the second network 445 (e.g., AP 485-a) has vacated or reduced the transmit power for one or more channels (in accordance with the information 430, for instance), the network entity 470-a may discontinue outputting the information 430. For example, a RAN node may stop broadcasting the SIB including the information 430 if one or more APs (e.g., AP 485-a) have applied the band sharing request (e.g., by vacating a channel or performing transmit power reduction, among other examples), where the application of the band sharing request may be identified based on one or more UE 475-a measurement reports. In some approaches, one or more measurements of the second network 445 (e.g., Wi-Fi network or AP 485-a) may be optional.

In some examples, the network entity 470-a may configure periodic transmission of EBCS uplink frames. For instance, the network entity 470-a may send one or more messages to the UE 475-a to configure the UE 475-a to transmit the periodic transmission of EBCS frames.

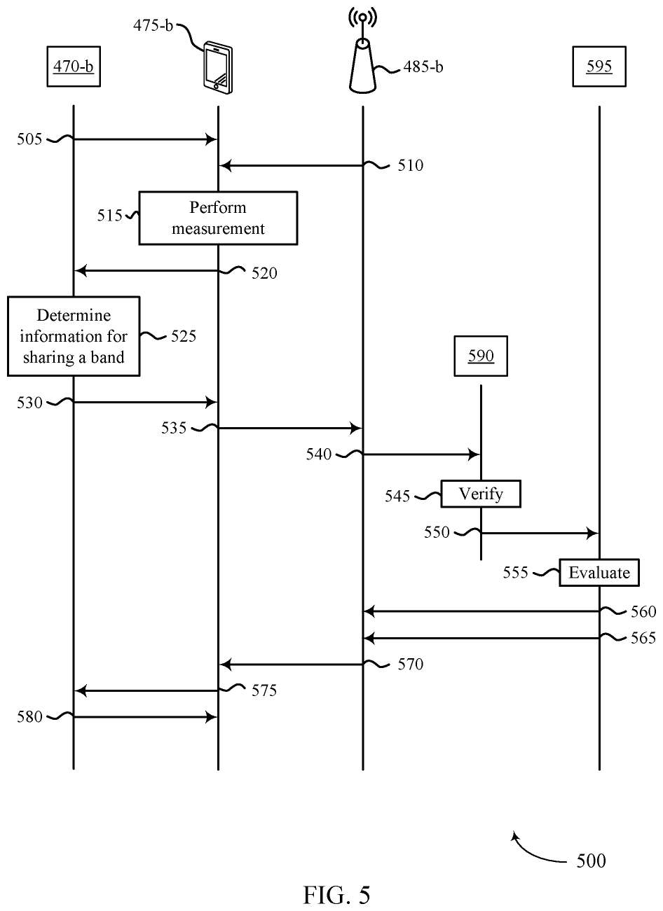

FIG. 5 shows an example of a process flow 500 that supports shared bands for multiple networks in accordance with one or more aspects of the present disclosure. The process flow 500 may include a UE 475-b, which may be an example of one or more of the UEs 115, UEs 115-a, STAs 304, or the UE 475-a, as described herein. The process flow 500 also includes a CMF entity 470-b, which may be an example of one or more of the CU 160, DU 165, RU 170, network entity 105, CU 160-a, DU 165-a, RU 170-a, RAN node, or network entity 470-a, as described herein. The CMF entity 470-b may be included in a first network (e.g., a cellular network). The process flow 500 additionally includes an AP 485-b, which may be an example of one or more of the AP 302 or the AP 485-a, as described herein. The process flow 500 may also include a proxy device 590 and an authorization server 595, which may be respective examples of the proxy device and the authorization server, as described with reference to FIG. 4. The AP 485-b, the proxy device 590, or the authorization server 595 may be included in a second network.

In the following description of the process flow 500, the signaling or communications between the UE 475-b, the CMF entity 470-b, the AP 485-b, the proxy device 590, or the authorization server 595 may be transmitted in a different order than the example order shown, or the operations performed by the UE 475-b, the CMF entity 470-b, the AP 485-b, the proxy device 590, or the authorization server 595 may be performed in different orders or at different times. Some operations may also be omitted from the process flow 500, or other operations may be added to the process flow 500. Further, although some operations or signaling may be shown to occur at different times for discussion purposes, these operations may actually occur at the same time or in overlapping time periods in some examples. In some examples, one or more of the operations described with reference to different elements may be performed by one element or one or more of the operations described with reference to one element may be divided to be performed by multiple elements.

At 505, the CMF entity 470-b may output (e.g., transmit) a configuration for the UE 475-b to use to measure a signal from the AP 485-b. For instance, the configuration may be output as described with reference to FIG. 4.

At 510, the AP 485-a may transmit (or the UE 475-b may receive) a signal. For example, the UE 475-b may receive the signal as described with reference to FIG. 4. The signal may be a beacon, a pilot signal, or a data signal, among other examples.

At 515, the UE 475-b may perform a measurement of the signal received from the AP 485-b. For instance, the UE 475-b may measure (e.g., detect, calculate, or compute, among other examples) one or more characteristics of the signal (e.g., RSSI, SNR) as described with reference to FIG. 4.

At 520, the UE 475-b may transmit the measurement of the signal to the CMF entity. For instance, the UE 475-b may transmit the measurement as described with reference to FIG. 4.

At 525, the CMF entity 470-b may determine information for sharing a frequency band between the first network and the second network. Determining the information for sharing the frequency band may be performed as described with reference to FIG. 4.

At 530, the CMF entity 470-b may output (or the UE 475-b may receive) the information for sharing the frequency band. For example, the CMF entity 470-b may output the information for sharing the frequency band as described with reference to FIG. 4.

At 535, the UE 475-b may transmit (or the AP 485-b may receive) the information for sharing the frequency band. For instance, the UE 475-b may transmit the information (e.g., in an EBCS uplink frame) as described with reference to FIG. 4.

At 540, the AP 485-b may transmit (or the proxy device 590 may receive) the information for sharing the frequency band. For example, the proxy device 590 may receive the information as described with reference to FIG. 4.

At 545, the proxy device 590 may verify the information or a frame. For instance, the proxy device 590 may verify the information for sharing the frequency band or a frame as described with reference to FIG. 4. For instance, the proxy device 590 may verify the information, the EBCS uplink frame, or a combination thereof. In some approaches, the proxy device 590 may perform the verification by verifying a certificate (via public key cryptography, for example) included in the information.

At 550, the proxy device 590 may transmit (or the authorization server 595 may receive) the information for sharing the frequency band. For instance, the proxy device 590 may transmit the information (e.g., via the second network) as described with reference to FIG. 4.

At 555, the authorization server 595 may evaluate the information for sharing the frequency band. For example, the authorization server 595 may evaluate the information as described with reference to FIG. 4. In some aspects, the authorization server 595 may evaluate the information based on one or more rules (e.g., policy(ies), SLA(s), law(s), or regulation(s), among other examples). For instance, the authorization server 595 may evaluate one or more control indications in the information based on an SLA between the authorization server 595 and the CMF entity 470-b or an SLA between the authorization server 595 and the AP 485-b. The authorization server 595 may perform the evaluation to generate a configuration of signaling for AP 485-b or one or more parameters for the first network (e.g., CMF entity 470-b).

At 560, the authorization server 595 may transmit (or the AP 485-b may receive) the configuration of signaling. For instance, the AP 485-b may receive the configuration of signaling as described with reference to FIG. 4. In some cases, the AP 485-b may apply the configuration of signaling. For example, the AP 485-b may vacate one or more channels or may reduce transmit power for one or more channels indicated by the configuration of signaling. In some approaches, the AP 485-b may vacate the one or more channels for a time period or may reduce transmit power for one or more channels for a time period indicated by the configuration of signaling.

At 565, the authorization server 595 may transmit (or the AP 485-b may receive) one or more parameters (e.g., operating parameters for the first network or the CMF entity 470-b). For instance, the AP 485-b may receive the one or more parameters as described with reference to FIG. 4.

At 570, the AP 485-b may transmit (or the UE 475-b may receive) the one or more parameters. For instance, the UE 475-b may receive the one or more parameters as described with reference to FIG. 4.

At 575, the UE 475-b may transmit (or the CMF entity 470-b may receive) the one or more parameters. For instance, the CMF entity 470-b may receive the one or more parameters as described with reference to FIG. 4. In some aspects, the CMF entity 470-b may evaluate the one or more parameters based on one or more rules (e.g., policy(ies), SLA(s), law(s), or regulation(s), among other examples). For instance, the CMF entity 470-b may evaluate the one or more parameters based on an SLA between the authorization server 595 and the CMF entity 470-b. The CMF entity 470-b may perform the evaluation to generate a configuration message for the UE 475-b. In some examples, the CMF entity 470-b may partially or fully apply the one or more parameters. For example, the CMF entity 470-b may control the first network to vacate one or more channels or to reduce transmit power on one or more channels.

At 580, the CMF entity 470-b may output (e.g., transmit) the configuration message to the UE 475-b to apply the one or more parameters. For instance, the configuration message may instruct the UE 475-b to vacate a channel, reduce transmit power on a channel, or switch channels (e.g., allocate communication resources on a non-vacated channel). In some cases, the CMF entity 470-b may reject the one or more parameters. For example, the first network may continue to operate without applying the one or more parameters.

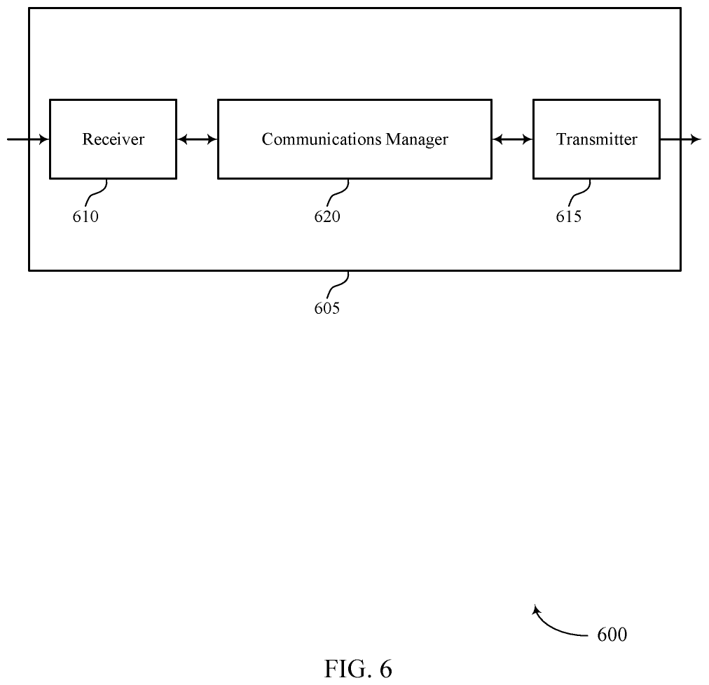

FIG. 6 shows a block diagram 600 of a device 605 that supports shared bands for multiple networks in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to shared bands for multiple networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to shared bands for multiple networks). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of shared bands for multiple networks as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for transmitting, to a first network, a measurement of a signal received from a second network. The communications manager 620 is capable of, configured to, or operable to support a means for receiving, from the first network, information for sharing a frequency band between the first network and the second network, where the information for sharing the frequency band is based on the measurement of the signal received from the second network. The communications manager 620 is capable of, configured to, or operable to support a means for transmitting, to the second network, the information for sharing the frequency band between the first network and the second network.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources.

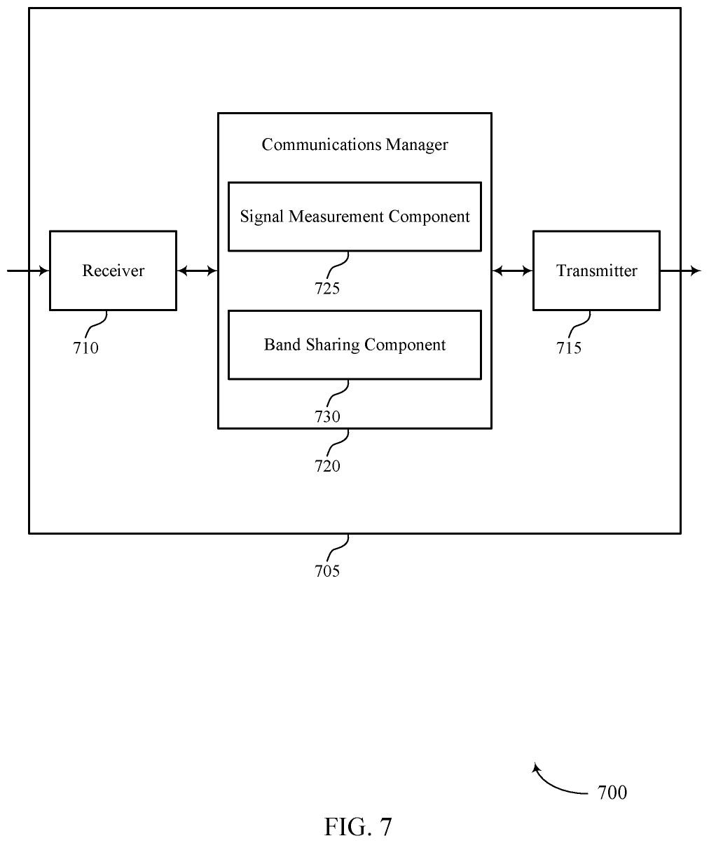

FIG. 7 shows a block diagram 700 of a device 705 that supports shared bands for multiple networks in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to shared bands for multiple networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to shared bands for multiple networks). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of shared bands for multiple networks as described herein. For example, the communications manager 720 may include a signal measurement component 725 a band sharing component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The signal measurement component 725 is capable of, configured to, or operable to support a means for transmitting, to a first network, a measurement of a signal received from a second network. The band sharing component 730 is capable of, configured to, or operable to support a means for receiving, from the first network, information for sharing a frequency band between the first network and the second network, where the information for sharing the frequency band is based on the measurement of the signal received from the second network. The band sharing component 730 is capable of, configured to, or operable to support a means for transmitting, to the second network, the information for sharing the frequency band between the first network and the second network.

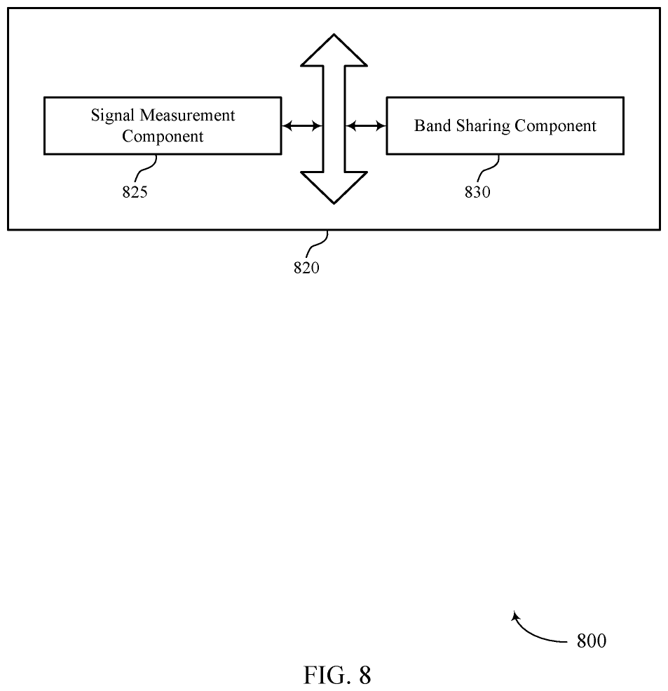

FIG. 8 shows a block diagram 800 of a communications manager 820 that supports shared bands for multiple networks in accordance with one or more aspects of the present disclosure. The communications manager 820 may be an example of aspects of a communications manager 620, a communications manager 720, or both, as described herein. The communications manager 820, or various components thereof, may be an example of means for performing various aspects of shared bands for multiple networks as described herein. For example, the communications manager 820 may include a signal measurement component 825 a band sharing component 830, or any combination thereof. Each of these components, or components or subcomponents thereof (e.g., one or more processors, one or more memories), may communicate, directly or indirectly, with one another (e.g., via one or more buses).

The signal measurement component 825 is capable of, configured to, or operable to support a means for transmitting, to a first network, a measurement of a signal received from a second network. The band sharing component 830 is capable of, configured to, or operable to support a means for receiving, from the first network, information for sharing a frequency band between the first network and the second network, where the information for sharing the frequency band is based on the measurement of the signal received from the second network. In some examples, the band sharing component 830 is capable of, configured to, or operable to support a means for transmitting, to the second network, the information for sharing the frequency band between the first network and the second network.

In some examples, the signal measurement component 825 is capable of, configured to, or operable to support a means for receiving, from the first network, a configuration for the UE to use to measure the signal from the second network. In some examples, the signal measurement component 825 is capable of, configured to, or operable to support a means for receiving, from the second network, the signal to generate the measurement of the signal from the second network using the configuration received from the first network.

In some examples, transmitting the information for sharing the frequency band includes transmitting the information in an enhanced broadcast service (EBCS) uplink frame.

In some examples, receiving the information for sharing the frequency band includes receiving the information from a broadcast via an SIB.

In some examples, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

In some examples, the band sharing component 830 is capable of, configured to, or operable to support a means for performing licensed communication with the first network based on the information for sharing the frequency band or unlicensed communication with the second network based on the information for sharing the frequency band.

In some examples, the band sharing component 830 is capable of, configured to, or operable to support a means for receiving one or more parameters from the second network, the one or more parameters associated with one or more signaling criteria for the first network to accommodate the second network in the frequency band. In some examples, the band sharing component 830 is capable of, configured to, or operable to support a means for transmitting the one or more parameters to the first network.

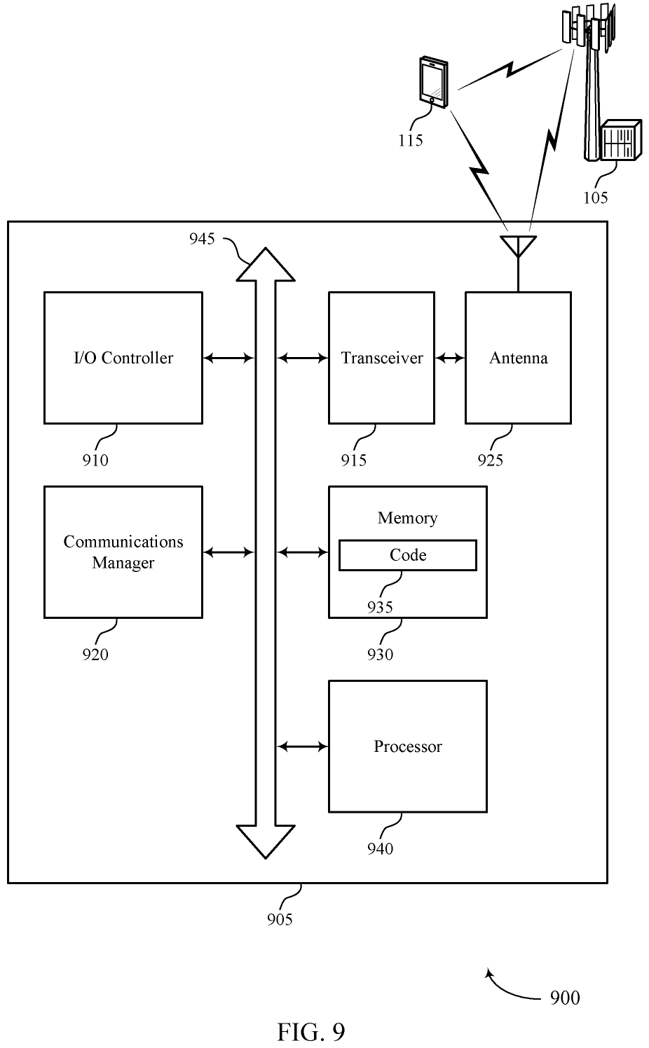

FIG. 9 shows a diagram of a system 900 including a device 905 that supports shared bands for multiple networks in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting shared bands for multiple networks). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for transmitting, to a first network, a measurement of a signal received from a second network. The communications manager 920 is capable of, configured to, or operable to support a means for receiving, from the first network, information for sharing a frequency band between the first network and the second network, where the information for sharing the frequency band is based on the measurement of the signal received from the second network. The communications manager 920 is capable of, configured to, or operable to support a means for transmitting, to the second network, the information for sharing the frequency band between the first network and the second network.

By including or configuring the communications manager 920 in accordance with examples as described herein, the device 905 may support techniques for improved communication reliability, reduced latency, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of shared bands for multiple networks as described herein, or the at least one processor 940 and the at least one memory 930 may be otherwise configured to, individually or collectively, perform or support such operations.

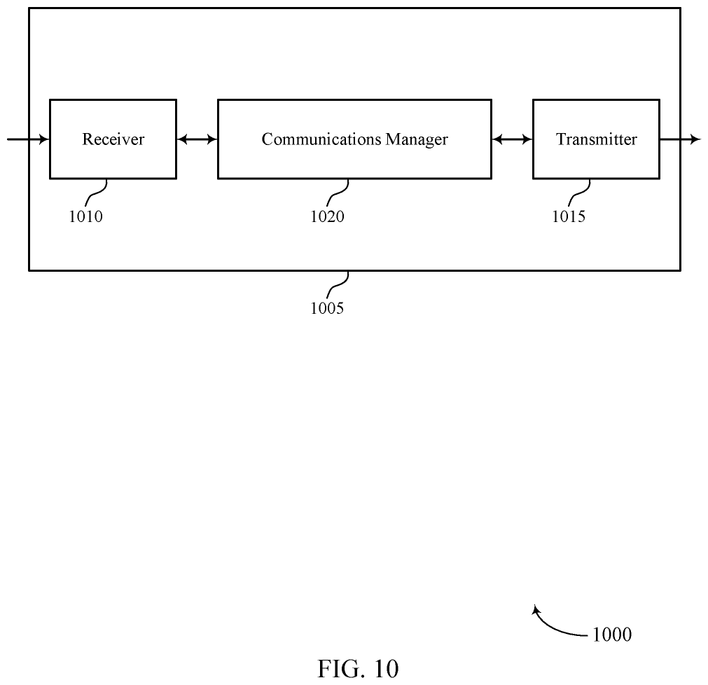

FIG. 10 shows a block diagram 1000 of a device 1005 that supports shared bands for multiple networks in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of shared bands for multiple networks as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for obtaining, at a first network from a UE, a measurement of a signal received at the UE from a second network. The communications manager 1020 is capable of, configured to, or operable to support a means for outputting, to the UE from the first network, information for sharing a frequency band between the first network and the second network, where the information for sharing the frequency band is based on the measurement of the signal received from the second network.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources.

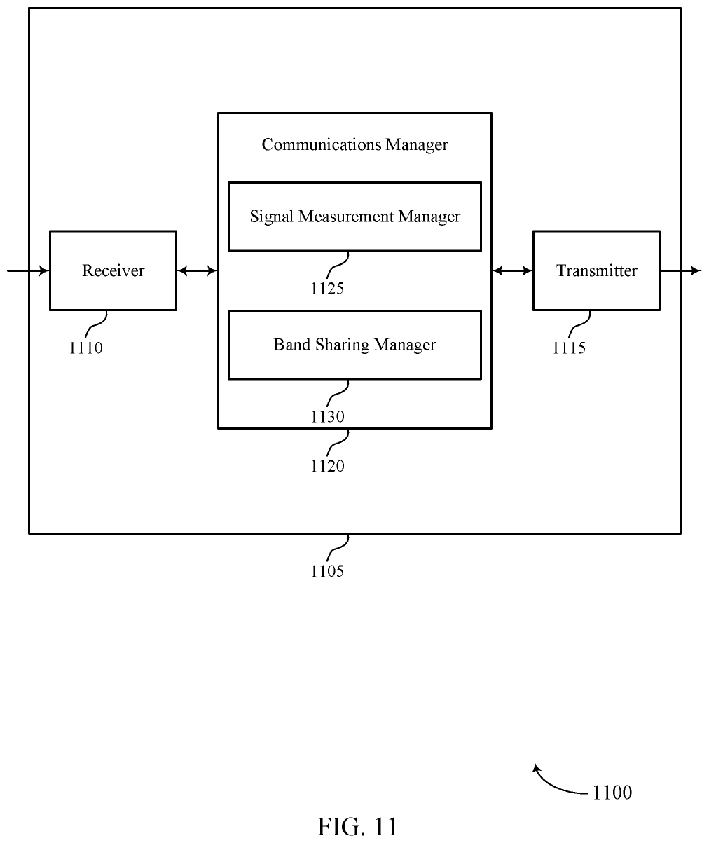

FIG. 11 shows a block diagram 1100 of a device 1105 that supports shared bands for multiple networks in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of shared bands for multiple networks as described herein. For example, the communications manager 1120 may include a signal measurement manager 1125 a band sharing manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The signal measurement manager 1125 is capable of, configured to, or operable to support a means for obtaining, at a first network from a UE, a measurement of a signal received at the UE from a second network. The band sharing manager 1130 is capable of, configured to, or operable to support a means for outputting, to the UE from the first network, information for sharing a frequency band between the first network and the second network, where the information for sharing the frequency band is based on the measurement of the signal received from the second network.

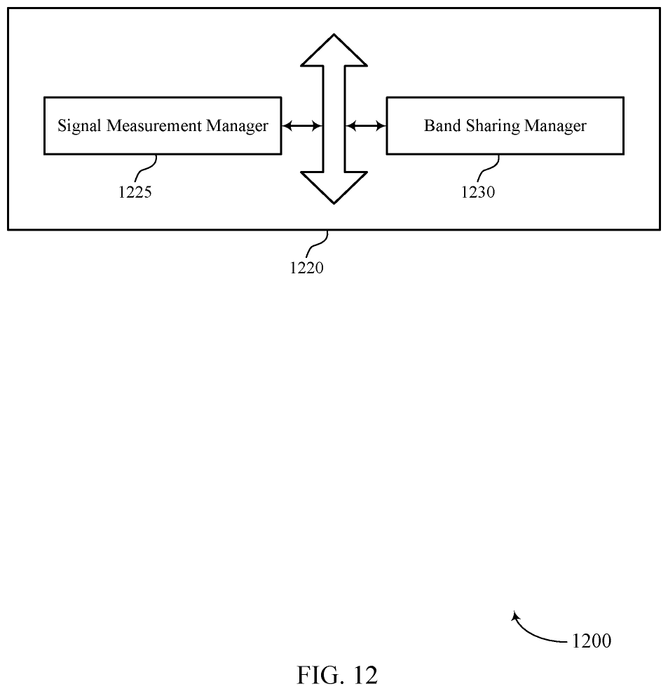

FIG. 12 shows a block diagram 1200 of a communications manager 1220 that supports shared bands for multiple networks in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of shared bands for multiple networks as described herein. For example, the communications manager 1220 may include a signal measurement manager 1225 a band sharing manager 1230, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The signal measurement manager 1225 is capable of, configured to, or operable to support a means for obtaining, at a first network from a UE, a measurement of a signal received at the UE from a second network. The band sharing manager 1230 is capable of, configured to, or operable to support a means for outputting, to the UE from the first network, information for sharing a frequency band between the first network and the second network, where the information for sharing the frequency band is based on the measurement of the signal received from the second network.

In some examples, the signal measurement manager 1225 is capable of, configured to, or operable to support a means for outputting, to the UE from the first network, a configuration for the UE to use to measure the signal from the second network, where the measurement of the signal is based on the configuration of the UE.

In some examples, outputting the information for sharing the frequency band includes broadcasting the information via an SIB.

In some examples, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

In some examples, the signal measurement manager 1225 is capable of, configured to, or operable to support a means for obtaining a measurement report from the UE indicating that a channel of the frequency band is vacated. In some examples, the band sharing manager 1230 is capable of, configured to, or operable to support a means for discontinuing outputting the information for sharing the frequency band based on the measurement report.

In some examples, the band sharing manager 1230 is capable of, configured to, or operable to support a means for obtaining one or more parameters from the UE, the one or more parameters associated with one or more signaling criteria for the first network to accommodate the second network in the frequency band. In some examples, the band sharing manager 1230 is capable of, configured to, or operable to support a means for communicating via the frequency band based on the one or more parameters.

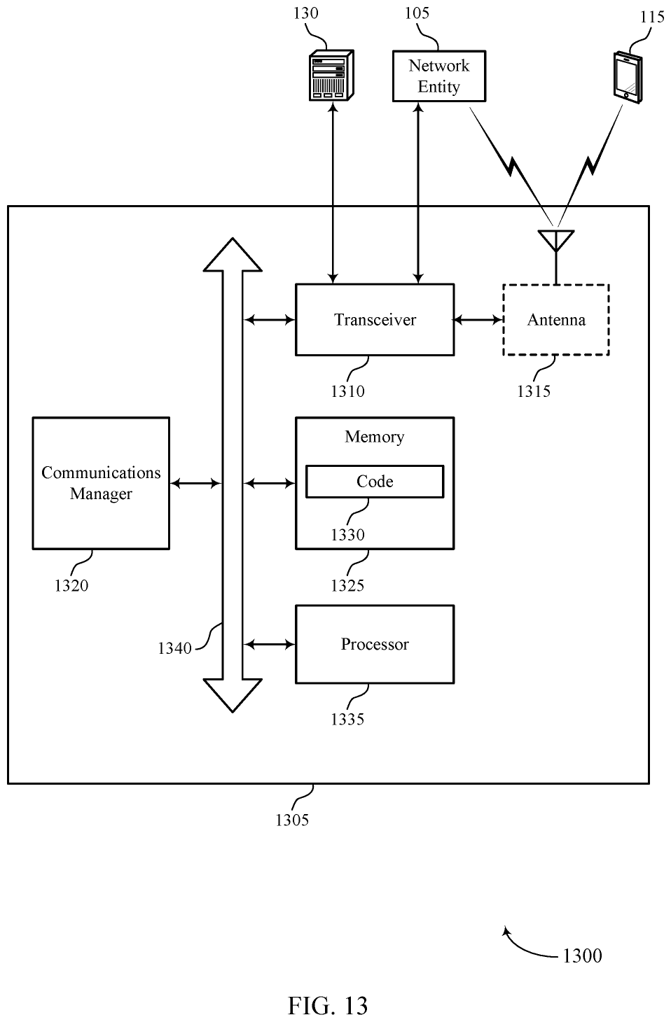

FIG. 13 shows a diagram of a system 1300 including a device 1305 that supports shared bands for multiple networks in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications using one or more wired interfaces, using one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting shared bands for multiple networks). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for obtaining, at a first network from a UE, a measurement of a signal received at the UE from a second network. The communications manager 1320 is capable of, configured to, or operable to support a means for outputting, to the UE from the first network, information for sharing a frequency band between the first network and the second network, where the information for sharing the frequency band is based on the measurement of the signal received from the second network.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of shared bands for multiple networks as described herein, or the at least one processor 1335 and the at least one memory 1325 may be otherwise configured to, individually or collectively, perform or support such operations.

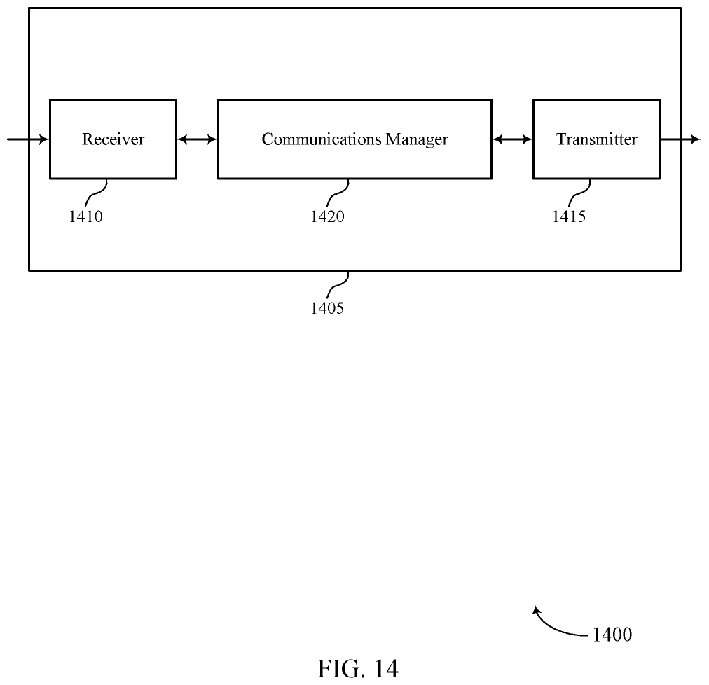

FIG. 14 shows a block diagram 1400 of a device 1405 that supports shared bands for multiple networks in accordance with one or more aspects of the present disclosure. The device 1405 may be an example of aspects of an AP as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to, individually or collectively, support or enable the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to shared bands for multiple networks). Information may be passed on to other components of the device 1405. The receiver 1410 may utilize a single antenna or a set of multiple antennas.

The transmitter 1415 may provide a means for transmitting signals generated by other components of the device 1405. The transmitter 1415 may utilize a single antenna or a set of multiple antennas.

The communications manager 1420, the receiver 1410, the transmitter 1415, or various combinations thereof or various components thereof may be examples of means for performing various aspects of shared bands for multiple networks as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor. If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

For example, the communications manager 1420 is capable of, configured to, or operable to support a means for receiving, from a UE, information for sharing a frequency band between a first network and a second network that includes the AP. The communications manager 1420 is capable of, configured to, or operable to support a means for transmitting, via the second network, the information for sharing the frequency band between the first network and the second network. The communications manager 1420 is capable of, configured to, or operable to support a means for receiving, via the second network, a configuration of signaling for the frequency band, the configuration of signaling based on the information for sharing the frequency band.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for reduced processing, reduced power consumption, or more efficient utilization of communication resources.

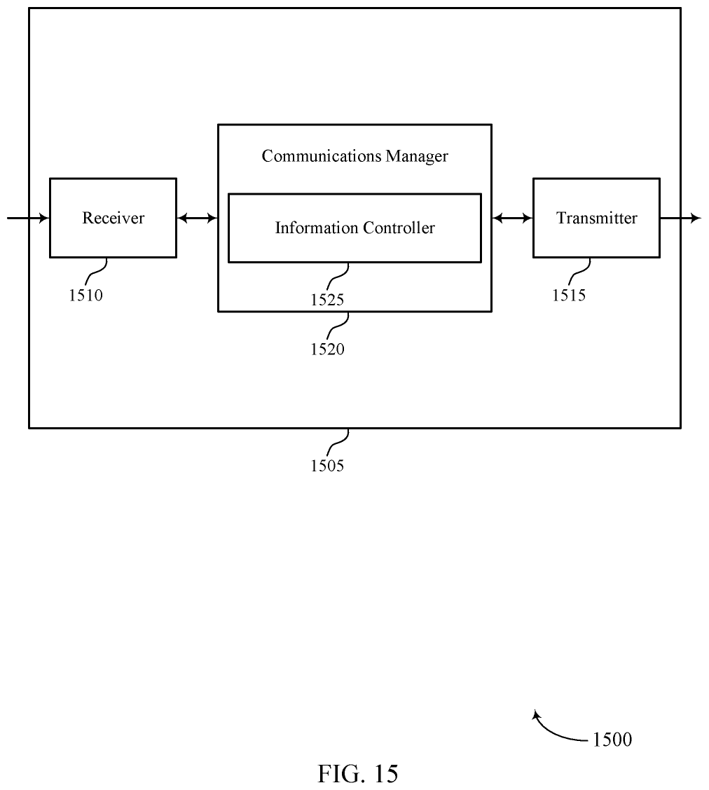

FIG. 15 shows a block diagram 1500 of a device 1505 that supports shared bands for multiple networks in accordance with one or more aspects of the present disclosure. The device 1505 may be an example of aspects of a device 1405 or an AP 302 as described herein. The device 1505 may include a receiver 1510, a transmitter 1515, and a communications manager 1520. The device 1505, or one or more components of the device 1505 (e.g., the receiver 1510, the transmitter 1515, and the communications manager 1520), may include at least one processor, which may be coupled with at least one memory, to support the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to shared bands for multiple networks). Information may be passed on to other components of the device 1505. The receiver 1510 may utilize a single antenna or a set of multiple antennas.

The transmitter 1515 may provide a means for transmitting signals generated by other components of the device 1505. The transmitter 1515 may utilize a single antenna or a set of multiple antennas.

The device 1505, or various components thereof, may be an example of means for performing various aspects of shared bands for multiple networks as described herein. For example, the communications manager 1520 may include an information controller 1525, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The information controller 1525 is capable of, configured to, or operable to support a means for receiving, from a UE, information for sharing a frequency band between a first network and a second network that includes the AP. The information controller 1525 is capable of, configured to, or operable to support a means for transmitting, via the second network, the information for sharing the frequency band between the first network and the second network. The information controller 1525 is capable of, configured to, or operable to support a means for receiving, via the second network, a configuration of signaling for the frequency band, the configuration of signaling based on the information for sharing the frequency band.

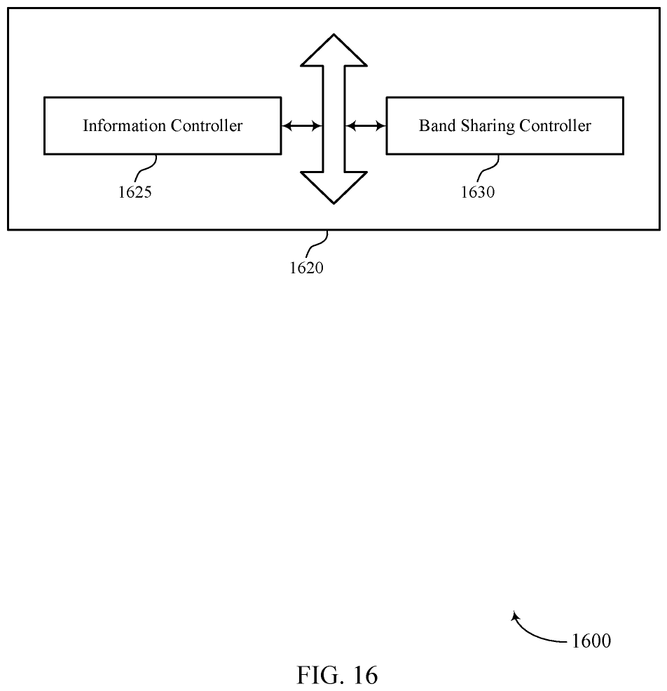

FIG. 16 shows a block diagram 1600 of a communications manager 1620 that supports shared bands for multiple networks in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of shared bands for multiple networks as described herein. For example, the communications manager 1620 may include an information controller 1625 a band sharing controller 1630, or any combination thereof. Each of these components, or components or subcomponents thereof (e.g., one or more processors, one or more memories), may communicate, directly or indirectly, with one another (e.g., via one or more buses).

The information controller 1625 is capable of, configured to, or operable to support a means for receiving, from a UE, information for sharing a frequency band between a first network and a second network that includes the AP. In some examples, the information controller 1625 is capable of, configured to, or operable to support a means for transmitting, via the second network, the information for sharing the frequency band between the first network and the second network. In some examples, the information controller 1625 is capable of, configured to, or operable to support a means for receiving, via the second network, a configuration of signaling for the frequency band, the configuration of signaling based on the information for sharing the frequency band.

In some examples, the band sharing controller 1630 is capable of, configured to, or operable to support a means for refraining from signaling in a channel of the frequency band based on the configuration of signaling for the frequency band.

In some examples, the band sharing controller 1630 is capable of, configured to, or operable to support a means for reducing a transmit power for signaling in a channel of the frequency band based on the configuration of signaling for the frequency band.

In some examples, receiving the information for sharing the frequency band includes receiving the information in an enhanced broadcast service (EBCS) uplink frame.

In some examples, the information for sharing the frequency band includes a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

In some examples, the configuration of signaling for the frequency band is formatted in accordance with transport layer security.

In some examples, the information controller 1625 is capable of, configured to, or operable to support a means for receiving one or more parameters via the second network, the one or more parameters associated with one or more signaling criteria for the first network to accommodate the second network in the frequency band. In some examples, the information controller 1625 is capable of, configured to, or operable to support a means for transmitting the one or more parameters to the UE.

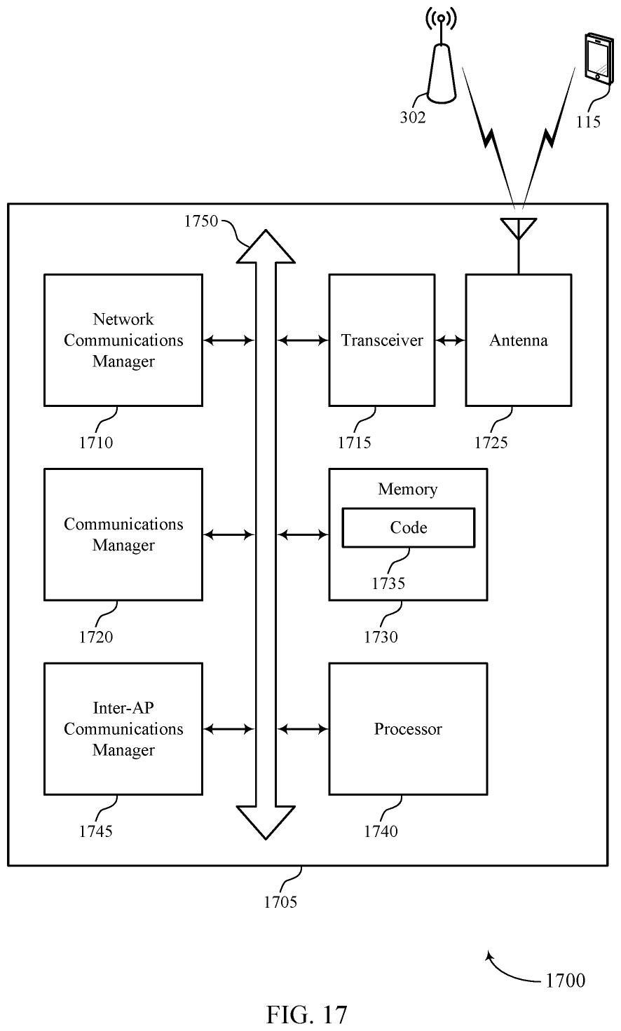

FIG. 17 shows a diagram of a system 1700 including a device 1705 that supports shared bands for multiple networks in accordance with one or more aspects of the present disclosure. The device 1705 may be an example of or include the components of a device 1405, a device 1505, or an AP as described herein. The device 1705 may include components for bi-directional voice and data communications including components for transmitting and receiving communications, such as a communications manager 1720, a network communications manager 1710, a transceiver 1715, an antenna 1725, at least one memory 1730, code 1735, at least one processor 1740, and an inter-AP communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network (e.g., via one or more wired backhaul links). For example, the network communications manager 1710 may manage the transfer of data communications for client devices, such as one or more UEs 115 (e.g., STAs).

In some cases, the device 1705 may include a single antenna 1725. However, in some other cases the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets and provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include RAM and ROM. The memory 1730 may store computer-readable, computer-executable code 1735 including instructions that, when executed by the processor 1740, cause the device 1705 to perform various functions described herein. In some cases, the memory 1730 may contain, among other things, a BIOS which may control basic hardware or software operation such as the interaction with peripheral components or devices.

The processor 1740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting shared bands for multiple networks). For example, the device 1705 or a component of the device 1705 may include a processor 1740 and memory 1730 coupled to the processor 1740, the processor 1740 and memory 1730 configured to perform various functions described herein.

The inter-AP communications manager 1745 may manage communications with other APs 302, and may include a controller or scheduler for controlling communications with UEs 115 in cooperation with other APs 302. For example, the inter-AP communications manager 1745 may coordinate scheduling for transmissions to APs 302 for various interference mitigation techniques such as beamforming or joint transmission. In some examples, the inter-AP communications manager 1745 may provide an X2 interface within an LTE/LTE-A wireless communication network technology to provide communication between APs 302.

For example, the communications manager 1720 is capable of, configured to, or operable to support a means for receiving, from a UE, information for sharing a frequency band between a first network and a second network that includes the AP. The communications manager 1720 is capable of, configured to, or operable to support a means for transmitting, via the second network, the information for sharing the frequency band between the first network and the second network. The communications manager 1720 is capable of, configured to, or operable to support a means for receiving, via the second network, a configuration of signaling for the frequency band, the configuration of signaling based on the information for sharing the frequency band.

By including or configuring the communications manager 1720 in accordance with examples as described herein, the device 1705 may support techniques for improved communication reliability, reduced latency, reduced power consumption, more efficient utilization of communication resources, improved coordination between devices, longer battery life, or improved utilization of processing capability.

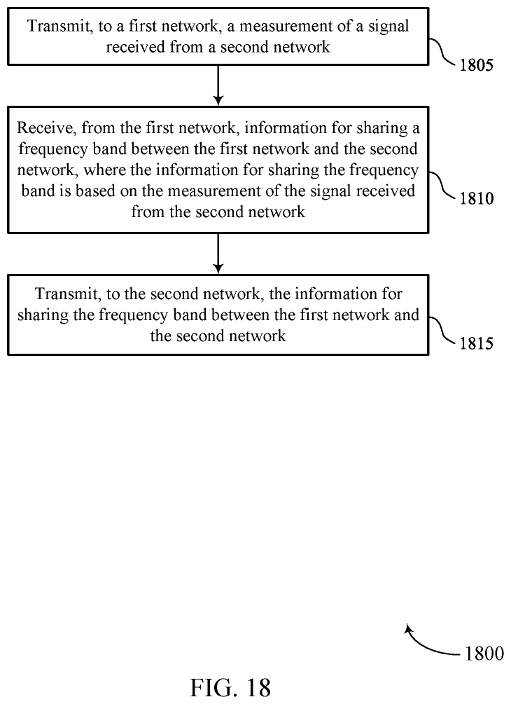

FIG. 18 shows a flowchart illustrating a method 1800 that supports shared bands for multiple networks in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include transmitting, to a first network, a measurement of a signal received from a second network. The operations of block 1805 may be performed in accordance with examples as disclosed herein. In some examples, aspects of the operations of 1805 may be performed by a signal measurement component 825 as described with reference to FIG. 8.

At 1810, the method may include receiving, from the first network, information for sharing a frequency band between the first network and the second network, where the information for sharing the frequency band is based on the measurement of the signal received from the second network. The operations of block 1810 may be performed in accordance with examples as disclosed herein. In some examples, aspects of the operations of 1810 may be performed by a band sharing component 830 as described with reference to FIG. 8.

At 1815, the method may include transmitting, to the second network, the information for sharing the frequency band between the first network and the second network. The operations of block 1815 may be performed in accordance with examples as disclosed herein. In some examples, aspects of the operations of 1815 may be performed by a band sharing component 830 as described with reference to FIG. 8.

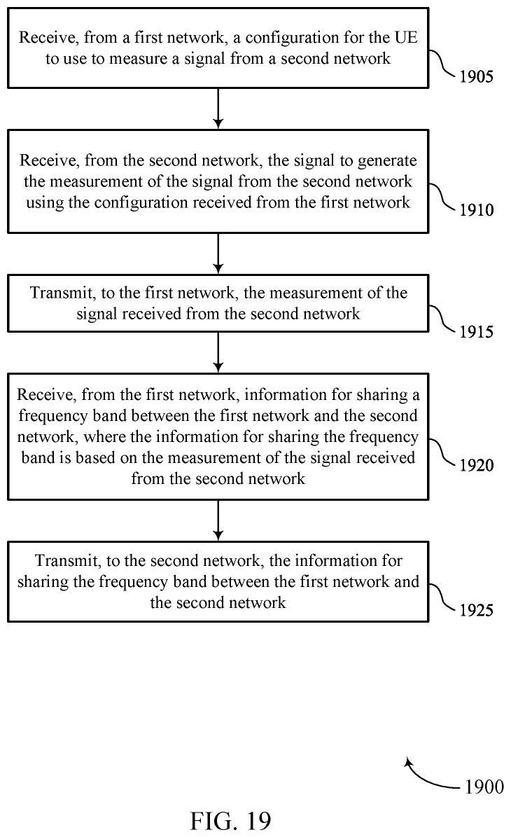

FIG. 19 shows a flowchart illustrating a method 1900 that supports shared bands for multiple networks in accordance with one or more aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may include receiving, from a first network, a configuration for the UE to use to measure a signal from a second network. The operations of block 1905 may be performed in accordance with examples as disclosed herein. In some examples, aspects of the operations of 1905 may be performed by a signal measurement component 825 as described with reference to FIG. 8.

At 1910, the method may include receiving, from the second network, the signal to generate a measurement of the signal from the second network using the configuration received from the first network. The operations of block 1910 may be performed in accordance with examples as disclosed herein. In some examples, aspects of the operations of 1910 may be performed by a signal measurement component 825 as described with reference to FIG. 8.

At 1915, the method may include transmitting, to the first network, the measurement of the signal received from the second network. The operations of block 1915 may be performed in accordance with examples as disclosed herein. In some examples, aspects of the operations of 1915 may be performed by a signal measurement component 825 as described with reference to FIG. 8.

At 1920, the method may include receiving, from the first network, information for sharing a frequency band between the first network and the second network, where the information for sharing the frequency band is based on the measurement of the signal received from the second network. The operations of block 1920 may be performed in accordance with examples as disclosed herein. In some examples, aspects of the operations of 1920 may be performed by a band sharing component 830 as described with reference to FIG. 8.

At 1925, the method may include transmitting, to the second network, the information for sharing the frequency band between the first network and the second network. The operations of block 1925 may be performed in accordance with examples as disclosed herein. In some examples, aspects of the operations of 1925 may be performed by a band sharing component 830 as described with reference to FIG. 8.

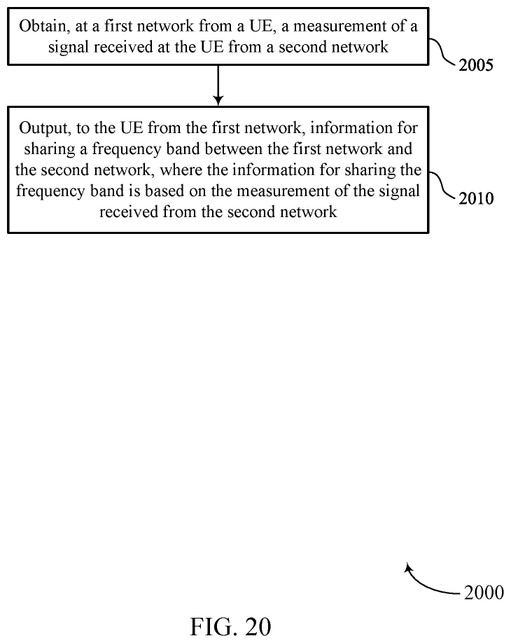

FIG. 20 shows a flowchart illustrating a method 2000 that supports shared bands for multiple networks in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include obtaining, at a first network from a UE, a measurement of a signal received at the UE from a second network. The operations of block 2005 may be performed in accordance with examples as disclosed herein. In some examples, aspects of the operations of 2005 may be performed by a signal measurement manager 1225 as described with reference to FIG. 12.

At 2010, the method may include outputting, to the UE from the first network, information for sharing a frequency band between the first network and the second network, where the information for sharing the frequency band is based on the measurement of the signal received from the second network. The operations of block 2010 may be performed in accordance with examples as disclosed herein. In some examples, aspects of the operations of 2010 may be performed by a band sharing manager 1230 as described with reference to FIG. 12.

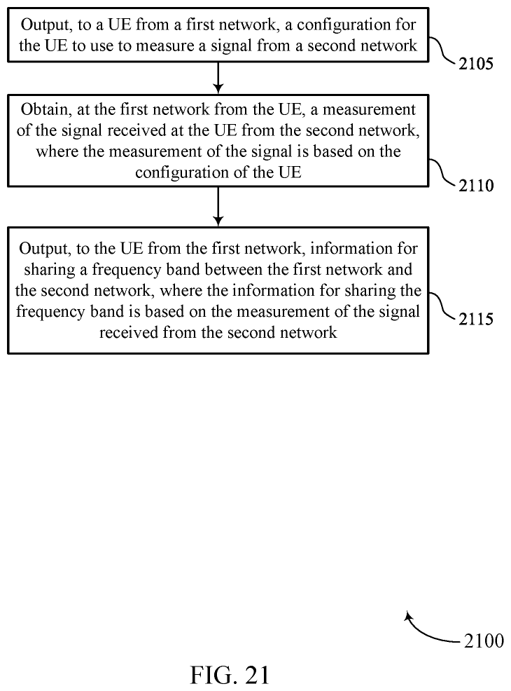

FIG. 21 shows a flowchart illustrating a method 2100 that supports shared bands for multiple networks in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include outputting, to a UE from a first network, a configuration for the UE to use to measure a signal from a second network. The operations of block 2105 may be performed in accordance with examples as disclosed herein. In some examples, aspects of the operations of 2105 may be performed by a signal measurement manager 1225 as described with reference to FIG. 12.

At 2110, the method may include obtaining, at the first network from the UE, a measurement of the signal received at the UE from the second network, where the measurement of the signal is based on the configuration of the UE. The operations of block 2110 may be performed in accordance with examples as disclosed herein. In some examples, aspects of the operations of 2110 may be performed by a signal measurement manager 1225 as described with reference to FIG. 12.

At 2115, the method may include outputting, to the UE from the first network, information for sharing a frequency band between the first network and the second network, where the information for sharing the frequency band is based on the measurement of the signal received from the second network. The operations of block 2115 may be performed in accordance with examples as disclosed herein. In some examples, aspects of the operations of 2115 may be performed by a band sharing manager 1230 as described with reference to FIG. 12.

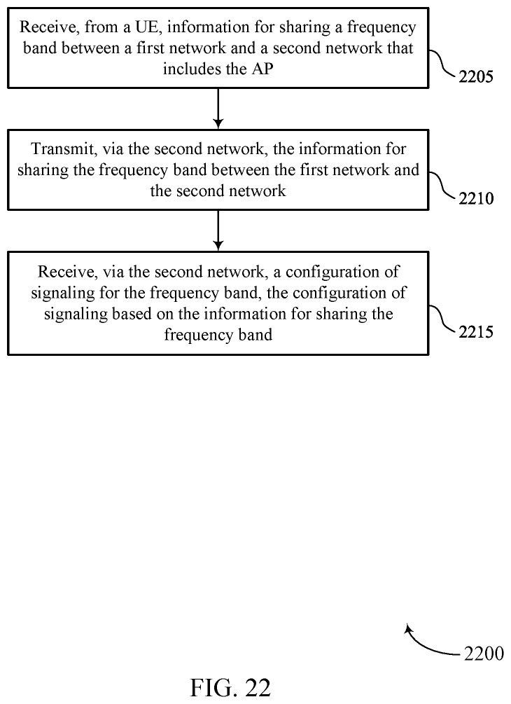

FIG. 22 shows a flowchart illustrating a method 2200 that supports shared bands for multiple networks in accordance with one or more aspects of the present disclosure. The operations of the method 2200 may be implemented by an AP or its components as described herein. For example, the operations of the method 2200 may be performed by an AP as described with reference to FIGS. 1 through 5 and 14 through 17. In some examples, an AP may execute a set of instructions to control the functional elements of the wireless AP to perform the described functions. Additionally, or alternatively, the wireless AP may perform aspects of the described functions using special-purpose hardware.

At 2205, the method may include receiving, from a UE, information for sharing a frequency band between a first network and a second network that includes the AP. The operations of block 2205 may be performed in accordance with examples as disclosed herein. In some examples, aspects of the operations of 2205 may be performed by an information controller 1625 as described with reference to FIG. 16.

At 2210, the method may include transmitting, via the second network, the information for sharing the frequency band between the first network and the second network. The operations of block 2210 may be performed in accordance with examples as disclosed herein. In some examples, aspects of the operations of 2210 may be performed by an information controller 1625 as described with reference to FIG. 16.

At 2215, the method may include receiving, via the second network, a configuration of signaling for the frequency band, the configuration of signaling based on the information for sharing the frequency band. The operations of block 2215 may be performed in accordance with examples as disclosed herein. In some examples, aspects of the operations of 2215 may be performed by an information controller 1625 as described with reference to FIG. 16.

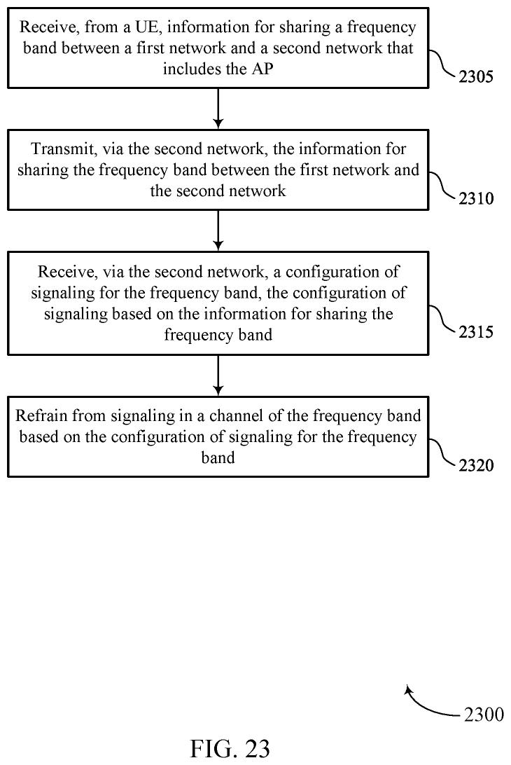

FIG. 23 shows a flowchart illustrating a method 2300 that supports shared bands for multiple networks in accordance with one or more aspects of the present disclosure. The operations of the method 2300 may be implemented by an AP or its components as described herein. For example, the operations of the method 2300 may be performed by an AP as described with reference to FIGS. 1 through 5 and 14 through 17. In some examples, an AP may execute a set of instructions to control the functional elements of the wireless AP to perform the described functions. Additionally, or alternatively, the wireless AP may perform aspects of the described functions using special-purpose hardware.

At 2305, the method may include receiving, from a UE, information for sharing a frequency band between a first network and a second network that includes the AP. The operations of block 2305 may be performed in accordance with examples as disclosed herein. In some examples, aspects of the operations of 2305 may be performed by an information controller 1625 as described with reference to FIG. 16.

At 2310, the method may include transmitting, via the second network, the information for sharing the frequency band between the first network and the second network. The operations of block 2310 may be performed in accordance with examples as disclosed herein. In some examples, aspects of the operations of 2310 may be performed by an information controller 1625 as described with reference to FIG. 16.

At 2315, the method may include receiving, via the second network, a configuration of signaling for the frequency band, the configuration of signaling based on the information for sharing the frequency band. The operations of block 2315 may be performed in accordance with examples as disclosed herein. In some examples, aspects of the operations of 2315 may be performed by an information controller 1625 as described with reference to FIG. 16.

At 2320, the method may include refraining from signaling in a channel of the frequency band based on the configuration of signaling for the frequency band. The operations of block 2320 may be performed in accordance with examples as disclosed herein. In some examples, aspects of the operations of 2320 may be performed by a band sharing controller 1630 as described with reference to FIG. 16.

The following provides an overview of aspects of the present disclosure:

Aspect 1: A method for wireless communications by a UE, comprising: transmitting, to a first network, a measurement of a signal received from a second network; receiving, from the first network, information for sharing a frequency band between the first network and the second network, wherein the information for sharing the frequency band is based at least in part on the measurement of the signal received from the second network; and transmitting, to the second network, the information for sharing the frequency band between the first network and the second network.

Aspect 2: The method of aspect 1, further comprising: receiving, from the first network, a configuration for the UE to use to measure the signal from the second network; and receiving, from the second network, the signal to generate the measurement of the signal from the second network using the configuration received from the first network.

Aspect 3: The method of any of aspects 1 through 2, wherein transmitting the information for sharing the frequency band comprises transmitting the information in an EBCS uplink frame.

Aspect 4: The method of any of aspects 1 through 3, wherein receiving the information for sharing the frequency band comprises receiving the information from a broadcast via a SIB.

Aspect 5: The method of any of aspects 1 through 4, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

Aspect 6: The method of any of aspects 1 through 5, further comprising: performing licensed communication with the first network based at least in part on the information for sharing the frequency band or unlicensed communication with the second network based at least in part on the information for sharing the frequency band.

Aspect 7: The method of any of aspects 1 through 6, further comprising: receiving one or more parameters from the second network, the one or more parameters associated with one or more signaling criteria for the first network to accommodate the second network in the frequency band; and transmitting the one or more parameters to the first network.

Aspect 8: A method for wireless communications by a network entity, comprising: obtaining, at a first network from a UE, a measurement of a signal received at the UE from a second network; and outputting, to the UE from the first network, information for sharing a frequency band between the first network and the second network, wherein the information for sharing the frequency band is based at least in part on the measurement of the signal received from the second network.

Aspect 9: The method of aspect 8, further comprising: outputting, to the UE from the first network, a configuration for the UE to use to measure the signal from the second network, wherein the measurement of the signal is based at least in part on the configuration of the UE.

Aspect 10: The method of any of aspects 8 through 9, wherein outputting the information for sharing the frequency band comprises broadcasting the information via a SIB.

Aspect 11: The method of any of aspects 8 through 10, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

Aspect 12: The method of any of aspects 8 through 11, further comprising: obtaining a measurement report from the UE indicating that a channel of the frequency band is vacated; and discontinuing outputting the information for sharing the frequency band based at least in part on the measurement report.

Aspect 13: The method of any of aspects 8 through 12, further comprising: obtaining one or more parameters from the UE, the one or more parameters associated with one or more signaling criteria for the first network to accommodate the second network in the frequency band; and communicating via the frequency band based at least in part on the one or more parameters.

Aspect 14: A method for wireless communications by an AP, comprising: receiving, from a UE, information for sharing a frequency band between a first network and a second network that includes the AP; transmitting, via the second network, the information for sharing the frequency band between the first network and the second network; and receiving, via the second network, a configuration of signaling for the frequency band, the configuration of signaling based at least in part on the information for sharing the frequency band.

Aspect 15: The method of aspect 14, further comprising: refraining from signaling in a channel of the frequency band based at least in part on the configuration of signaling for the frequency band.

Aspect 16: The method of any of aspects 14 through 15, further comprising: reducing a transmit power for signaling in a channel of the frequency band based at least in part on the configuration of signaling for the frequency band.

Aspect 17: The method of any of aspects 14 through 16, wherein receiving the information for sharing the frequency band comprises receiving the information in an EBCS uplink frame.

Aspect 18: The method of any of aspects 14 through 17, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

Aspect 19: The method of any of aspects 14 through 18, wherein the configuration of signaling for the frequency band is formatted in accordance with transport layer security.

Aspect 20: The method of any of aspects 14 through 19, further comprising: receiving one or more parameters via the second network, the one or more parameters associated with one or more signaling criteria for the first network to accommodate the second network in the frequency band; and transmitting the one or more parameters to the UE.

Aspect 21: A UE comprising one or more memories storing processor-executable code, and one or more processors coupled with the one or more memories and individually or collectively operable to execute the code to cause the UE to perform a method of any of aspects 1 through 7.

Aspect 22: A UE comprising at least one means for performing a method of any of aspects 1 through 7.

Aspect 23: A non-transitory computer-readable medium storing code the code comprising instructions executable by one or more processors to perform a method of any of aspects 1 through 7.

Aspect 24: A network entity comprising one or more memories storing processor-executable code, and one or more processors coupled with the one or more memories and individually or collectively operable to execute the code to cause the network entity to perform a method of any of aspects 8 through 13.

Aspect 25: A network entity comprising at least one means for performing a method of any of aspects 8 through 13.

Aspect 26: A non-transitory computer-readable medium storing code the code comprising instructions executable by one or more processors to perform a method of any of aspects 8 through 13.

Aspect 27: An AP comprising one or more memories storing processor-executable code, and one or more processors coupled with the one or more memories and individually or collectively operable to execute the code to cause the AP to perform a method of any of aspects 14 through 20.

Aspect 28: An AP comprising at least one means for performing a method of any of aspects 14 through 20.

Aspect 29: A non-transitory computer-readable medium storing code the code comprising instructions executable by one or more processors to perform a method of any of aspects 14 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a first network, a measurement of a signal received from a second network;
receive, from the first network, information for sharing a frequency band between the first network and the second network, wherein the information for sharing the frequency band is based at least in part on the measurement of the signal received from the second network; and
transmit, to the second network, the information for sharing the frequency band between the first network and the second network.

2. The UE of claim 1, wherein the one or more processors are individually or collectively further operable to execute the code to cause the UE to:
receive, from the first network, a configuration for the UE to use to measure the signal from the second network; and
receive, from the second network, the signal to generate the measurement of the signal from the second network using the configuration received from the first network.

3. The UE of claim 1, wherein, to transmit the information for sharing the frequency band, the one or more processors are individually or collectively operable to execute the code to cause the UE to transmit the information in an enhanced broadcast service (EBCS) uplink frame.

4. The UE of claim 1, wherein, to receive the information for sharing the frequency band, one or more processors are individually or collectively further operable to execute the code to cause the UE to receive the information from a broadcast via a system information block (SIB).

5. The UE of claim 1, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

6. The UE of claim 1, wherein the one or more processors are individually or collectively further operable to execute the code to cause the UE to:
perform licensed communication with the first network based at least in part on the information for sharing the frequency band or unlicensed communication with the second network based at least in part on the information for sharing the frequency band.

7. The UE of claim 1, wherein the one or more processors are individually or collectively further operable to execute the code to cause the UE to:
receive one or more parameters from the second network, the one or more parameters associated with one or more signaling criteria for the first network to accommodate the second network in the frequency band; and
transmit the one or more parameters to the first network.

8. A network entity, comprising:
one or more memories storing processor-executable code; and
one or more processors coupled with the one or more memories and individually or collectively operable to execute the code to cause the network entity to:
obtain, at a first network from a user equipment (UE), a measurement of a signal received at the UE from a second network; and
output, to the UE from the first network, information for sharing a frequency band between the first network and the second network, wherein the information for sharing the frequency band is based at least in part on the measurement of the signal received from the second network.

9. The network entity of claim 8, wherein the one or more processors are individually or collectively further operable to execute the code to cause the network entity to:
output, to the UE from the first network, a configuration for the UE to use to measure the signal from the second network, wherein the measurement of the signal is based at least in part on the configuration of the UE.

10. The network entity of claim 8, wherein, to output the information for sharing the frequency band, the one or more processors are individually or collectively operable to execute the code to cause the UE to broadcast the information via a system information block (SIB).

11. The network entity of claim 8, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

12. The network entity of claim 8, wherein the one or more processors are individually or collectively further operable to execute the code to cause the network entity to:
obtain a measurement report from the UE indicating that a channel of the frequency band is vacated; and
discontinue outputting the information for sharing the frequency band based at least in part on the measurement report.

13. The network entity of claim 8, wherein the one or more processors are individually or collectively further operable to execute the code to cause the network entity to:
obtain one or more parameters from the UE, the one or more parameters associated with one or more signaling criteria for the first network to accommodate the second network in the frequency band; and
communicate via the frequency band based at least in part on the one or more parameters.

14. An access point (AP), comprising:
one or more memories storing processor-executable code; and
one or more processors coupled with the one or more memories and individually or collectively operable to execute the code to cause the AP to:
receive, from a user equipment (UE), information for sharing a frequency band between a first network and a second network that includes the AP;
transmit, via the second network, the information for sharing the frequency band between the first network and the second network; and
receive, via the second network, a configuration of signaling for the frequency band, the configuration of signaling based at least in part on the information for sharing the frequency band.

15. The AP of claim 14, wherein the one or more processors are individually or collectively further operable to execute the code to cause the AP to:
refrain from signaling in a channel of the frequency band based at least in part on the configuration of signaling for the frequency band.

16. The AP of claim 14, wherein the one or more processors are individually or collectively further operable to execute the code to cause the AP to:
reduce a transmit power for signaling in a channel of the frequency band based at least in part on the configuration of signaling for the frequency band.

17. The AP of claim 14, wherein, to receive the information for sharing the frequency band, the one or more processors are individually or collectively operable to execute the code to cause the UE to receive the information in an enhanced broadcast service (EBCS) uplink frame.

18. The AP of claim 14, wherein the information for sharing the frequency band comprises a certificate associated with the first network, a control indication to vacate a channel of the frequency band, a control indication to reduce transmit power in a channel of the frequency band, an indication of a time period for one or more control indications, an indication of time, an identifier of the first network, or any combination thereof.

19. The AP of claim 14, wherein the configuration of signaling for the frequency band is formatted in accordance with transport layer security.

20. The AP of claim 14, wherein the one or more processors are individually or collectively further operable to execute the code to cause the AP to:
receive one or more parameters via the second network, the one or more parameters associated with one or more signaling criteria for the first network to accommodate the second network in the frequency band; and
transmit the one or more parameters to the UE.
